(19) United States
(12) Patent Application Publication
(10) Pub. No.: US 2026/0103128 A1
(43) Pub. Date: Apr. 16, 2026

(54) COMPONENT FOR VEHICLE INTERIOR

(71) Applicant: Yanfeng International Automotive Technology Co. Ltd., Novi, MI (US)

(72) Inventors: Yeqian CHU, Shanghai (CN); Jie SUN, Shanghai (CN); Minjie JIANG, Shanghai (CN); Liyong WANG, Shanghai (CN)

(21) Appl. No.: 19/421,053

(22) Filed: Dec. 16, 2025

Related U.S. Application Data
(63) Continuation-in-part of application No. PCT/CN2024/099139, filed on Jun. 14, 2024.

(30) Foreign Application Priority Data
Jun. 16, 2023 (CN) 202310721062.0

(51) Int. Cl. B60N 2/64; B32B 1/00; B32B 5/02; B32B 5/18; B32B 5/24; B32B 27/06; B32B 27/12; B32B 27/30; B32B 27/40

(52) U.S. Cl. CPC B60N 2/64; B32B 1/00; B32B 5/02; B32B 5/18; B32B 5/245; B32B 27/065; B32B 27/12; B32B 27/304; B32B 27/40; B32B 2262/0284; B32B 2266/0278; B32B 2305/70; B32B 2601/00

(57) ABSTRACT

A component for a vehicle interior configured to facilitate recycling material of construction at end of life is disclosed. The component may comprise an assembly comprising a composite structure comprising a cover and an intermediate layer and a base; material of construction for the composite structure as a whole/unit may comprise of recyclable materials selected from a group of polymer materials comprising a mono-material/single-material group, such as a thermoplastic polymer/copolyester elastomer group. The composite structure may comprise the cover comprising a surface layer as a rigid segment and an intermediate layer comprising a foam layer and/or a fabric layer and the base comprising a foam layer providing a compressible segment. A method of recovering materials of construction of the composite structure substantially as the whole/unit for reuse is also disclosed; the assembly may be configured to be disassembled to facilitate efficient recovery/reuse of materials of construction of the composite structure.

### CROSS-REFERENCE TO RELATED APPLICATIONS

The present application is a continuation-in-part of PCT/International Patent Application No. PCT/CN2024/099139 titled “RECYCLABLE SKIN FOR VEHICLE INTERIOR AND VEHICLE INTERIOR COMPONENT COMPRISING SAME” filed Jun. 14, 2024, that claims the benefit of Chinese Patent Application No. 202310721062.0 titled “RECYCLABLE SKIN FOR VEHICLE INTERIOR AND VEHICLE INTERIOR COMPONENT COMPRISING SAME” filed Jun. 16, 2023.

The present application claims priority to and incorporates by reference in full: (1) PCT/International Patent Application No. PCT/CN2024/099139 titled “RECYCABLE SKIN FOR VEHICLE INTERIOR AND VEHICLE INTERIOR COMPONENT COMPRISING SAME” filed Jun. 14, 2024; and (2) Chinese Patent Application No. 202310721062.0 titled “RECYCLABLE SKIN FOR VEHICLE INTERIOR AND VEHICLE INTERIOR COMPONENT COMPRISING SAME” filed Jun. 16, 2023.

### FIELD

The present invention relates to a component for a vehicle interior.

The present invention also relates to a component for a vehicle interior comprising a composite structure configured to facilitate efficient recycling/recovery of material of construction at end of life of the component.

### BACKGROUND

It is known to provide a vehicle interior component comprising a composite structure of materials that may be separated for recycling/recovery at end of life of the component.

It would be advantageous to provide a component for a vehicle interior comprising a composite structure configured to facilitate efficient recycling/recovery of material of construction at end of life of the component.

It would be advantageous to provide a component for a vehicle interior comprising a composite structure configured to facilitate efficient recycling/recovery of material of construction at end of life of the component by use of mono-materials of a single polymer group.

It would be advantageous to provide a component for a vehicle interior comprising a composite structure configured to facilitate efficient recycling/recovery of material of construction at end of life of the component by use of mono-materials of a single polymer group selected to enhance performance of the component during use in the vehicle interior.

It would be advantageous to provide a component for a vehicle interior comprising a composite structure configured to facilitate efficient recycling/recovery of material of construction at end of life of the component by use of mono-materials of a single polymer group for the composite structure as a whole/unit and selected to enhance performance of the component during use in the vehicle interior.

### SUMMARY

The present invention relates to a component for a vehicle interior configured to facilitate recycling and reuse of material of construction at end of life. The component may comprise an assembly comprising a composite structure; the composite structure as a unit may comprise a cover and a base; the composite structure as the unit may comprise material of construction; material of construction for the composite structure as the unit comprise recyclable materials; the assembly may be configured to be disassembled to facilitate recycling and reuse of material of construction of the composite structure as the unit. The assembly may comprise a frame; the composite structure may be formed on the frame; and the frame may comprise a metal material. The composite structure as the unit may comprise an intermediate layer between the cover and the base. The assembly may be configured to be disassembled to facilitate recovery of material of construction of the composite structure as the unit by separation of the composite structure as the unit from the frame and reducing of the composite structure as the unit by a mechanical process for reclaiming and recovery of material of construction. The mechanical process may comprise shredding. The assembly may comprise a seat assembly; the seat assembly may comprise a seat back and a seat cushion. The cover may comprise a skin layer comprising a polymer material comprising a generally rigid segment formed to provide an exterior surface comprising a decorative effect for the composite structure. Material of construction of the composite structure may comprise a polymer material selected from a group of polymer materials comprising (a) a polyolefin group; (b) a thermoplastic elastomeric group; (c) an elastomeric group; (d) thermoplastic copolymer elastomer; (e) thermoplastic copolyester elastomer; (f) thermoplastic polymer; (g) polymer material; (h) resin material. The group of polymer materials of material of construction for the composite structure as a unit may comprise a mono-material for recyclability; the mono-material may comprise a single material group. Material of construction of the composite structure may comprise a thermoplastic polyester material comprising more than 70 percent of total weight of the composite structure. The composite structure may be configured to provide a surface effect at the cover; the surface effect may comprise at least one of (a) softness; (b) compressibility, (c) elastic deformability; (d) resilience; (e) decorative appearance; (f) visual effect; (g) durability. The base of the composite structure may comprise a foam material; the base of the composite structure may comprise a fabric layer. The composite structure may comprise a generally rigid segment and a generally compressible segment. Ratio of a generally rigid segment of the thermoplastic polymer of the composite structure may comprise from between 25 to 60 percent of total thermoplastic polymer; ratio of a generally compressible segment of the thermoplastic polymer of the composite structure may comprise from between 40 to 75 percent of total thermoplastic polymer. The composite structure may comprise (a) the cover comprising a surface layer and (b) an intermediate layer comprising a first foam layer and a fabric layer and (c) the base comprising a second foam layer. The intermediate layer may comprise at least two layers of recyclable material comprising a fabric material and a foam material providing a generally compressible segment between the cover and the base. Material of construction for the composite structure may comprise additives; additives may comprise a colorant and/or an antioxidant.

The present invention relates to method of recovering materials of construction of a composite structure of a component for a vehicle interior to facilitate recycling and reuse of materials of construction at end of life of the component. The method may comprise the steps of: providing the component as an assembly comprising the composite structure and a frame and separating the composite structure as a unit from the frame by disassembly and shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure. The composite structure as a unit may comprise a cover and an intermediate layer and a base; the composite structure as a unit may be configured to be disassembled from the frame to facilitate recovery of materials of construction of the composite structure as the unit by separation of the composite structure as the unit from the frame and reducing of the composite structure as the unit by a mechanical process for reclaiming and recovery of materials of construction. Material of construction for the composite structure may comprise additives; additives may comprise a colorant and/or an antioxidant.

The present invention relates to a component for a vehicle interior configured to facilitate recycling and reuse of materials of construction at end of life may comprise an assembly comprising a composite structure; the composite structure as a unit may comprise a cover and an intermediate layer and a base; the composite structure as the unit may comprise materials of construction; materials of construction for the composite structure as the unit may comprise recyclable materials; the assembly may be configured to be disassembled to facilitate recycling and reuse of materials of construction of the composite structure as the unit; the assembly may comprise a frame; the composite structure may be provided on the frame; the composite structure may be formed on the frame; the frame may comprise a metal material; the assembly may be configured to be disassembled to facilitate recycling and reuse of materials of construction of the composite structure as the unit by separation of the composite structure as the unit from the frame; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the mechanical process may comprise shredding; the assembly may comprise a seat assembly; the seat assembly may comprise a seat back and a seat cushion; the base may comprise a foam material; the intermediate layer may comprise a set of intermediate layers; the cover may comprise a skin and/or skin layer; the cover may comprise a skin comprising a polymer material formed to provide an exterior surface comprising a decorative effect for the composite structure of the component; the intermediate layer may comprise at least two layers of recyclable material between the cover and the base; the polymer material may be selected from a group of polymer materials comprising a polyolefin group, a thermoplastic elastomeric group and/or an elastomeric group; the group of polymer materials of materials of construction for the composite structure as a unit may comprise a mono-material for recyclability; the mono-material may comprise a single material group; the composite structure as the unit may comprise a sub-assembly; the composite structure may be configured to provide a surface effect at the cover; the surface effect may comprise at least one of softness, compressibility, elastic deformability, resilience, decorative appearance, visual effect and/or durability; the thermoplastic copolyester elastomer forming the composite structure may comprise a generally rigid segment and a generally compressible segment; the base of the composite structure may comprise a foam layer; the composite structure may comprise a fabric layer; material of construction of the composite structure comprising the thermoplastic polyester material may comprise more than 70 percent of total weight of the composite structure; the composite structure may comprise a cover comprising a surface layer and intermediate layer comprising a first foam layer and a fabric layer and the base comprising a second foam layer; the composite structure may comprise the cover comprising a surface layer and an intermediate layer comprising a fabric layer and a base comprising a first foam layer and a second foam layer; the thermoplastic copolyester elastomer may comprise at least 90 percent of the composite structure by weight; the material of construction for the composite structure may comprise additives; the additives may comprise a colorant and/or an antioxidant.

The present invention relates to a method of recovering materials of construction of a composite structure of a component for a vehicle interior to facilitate recycling and reuse of materials of construction at end of life of the component may comprise the steps of providing the component as an assembly comprising the composite structure and a frame, separating the composite structure as a unit from the frame by disassembly, shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure; the composite structure as a unit may comprise a cover and an intermediate layer and a base; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction.

The present invention relates to a component for a vehicle interior configured to facilitate recycling and reuse of materials of construction at end of life may comprise an assembly comprising a composite structure; the composite structure as a unit may comprise a cover and an intermediate layer and a base; the composite structure as the unit may comprise materials of construction; materials of construction for the composite structure as the unit may comprise recyclable materials; the assembly may be configured to be disassembled to facilitate recycling and reuse of materials of construction of the composite structure as the unit; materials of construction for the composite structure may consist essentially of recyclable materials; materials of construction may be selected from a family of polymer materials; materials of construction of the composite structure as the unit comprising the cover and the intermediate layer and the base may be selected from a family of polymer materials; materials of construction for the cover and the intermediate layer and the base may be selected from a mono-material family of polymer materials. The assembly may comprise a frame; the composite structure may be provided on the frame; the composite structure may be formed on the frame; the frame may comprise a metal material; the assembly may be configured to be disassembled to facilitate recycling and reuse of materials of construction of the composite structure as the unit by separation of the composite structure as the unit from the frame; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the mechanical process may comprise shredding; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may comprise a seat assembly; the seat assembly may comprise a seat back and a seat cushion; the seat assembly may comprise a frame; the frame may comprise at least one mechanism; the frame may comprise a metal material; the composite structure may be formed on the frame; the composite structure may be removable from the frame at end of life; the assembly may comprise a console; the assembly may comprise a trim panel; the assembly may comprise a door panel; the assembly may comprise an instrument panel; the base may comprise a foam material; the intermediate layer may comprise a set of intermediate layers; the cover may comprise a skin and/or skin layer; the composite structure as a unit may comprise a cover and an intermediate layer and a base; the family of polymer materials of materials of construction of the composite structure may comprise a mono-material family of polymer materials selected to be recovered to facilitate recycling and reuse after shredding the composite structure as a unit; the cover may comprise a skin comprising a polymer material formed to provide an exterior surface comprising a decorative effect for the composite structure of the component; the intermediate layer may comprise at least two layers of recyclable material between the cover and the base; the base of the composite structure may comprise a foam material; the frame of the assembly of the component may comprise a metal material; materials of construction for the cover, the pad and the base may comprise a polymer material configured for recyclability and reuse after reduction by a mechanical process; the polymer material may be selected from a group of polymer materials comprising a polyolefin group, a thermoplastic elastomeric group and/or an elastomeric group; the group of polymer materials of materials of construction for the composite structure as a unit may comprise a mono-material for recyclability; the mono-material may comprise a single material group; the composite structure as the unit may comprise a sub-assembly; the composite structure may be configured to provide a surface effect at the cover; the surface effect may comprise at least one of softness, compressibility, elastic deformability, resilience, decorative appearance, visual effect, durability, etc.; the material of construction for the composite structure may comprise a material comprising a thermoplastic copolyester elastomer by calendering and/or casting; the thermoplastic copolyester elastomer forming the composite structure may comprise a generally rigid segment and a generally compressible segment; the generally rigid segment may comprise a hard segment and the generally compressible segment may comprise a soft segment; the generally rigid segment of the thermoplastic copolyester elastomer may comprise at least one of poly (butylene terephthalate), poly (ethylene terephthalate), poly (trimethylene terephthalate), poly (trimethylene terephthalate)/poly (butylene terephthalate), poly (2,6-naphthalate), poly (trimethylene terephthalate), poly (ethylene terephthalate)/polybutylene terephthalate copolymers, poly (dimethyl terephthalate/m-xylylene)/1,4-butanediol copolymers, poly (2,5-furan dicarboxylate), poly (2,5-furandicarboxylic acid) propylene glycol ester, poly (2,5-furandicarboxylate), poly (2,5-furan dicarboxylate) and/or a combination; the generally compressible segment of the thermoplastic copolyester elastomer may comprise at least one of polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide and/or a combination, preferably, polyethylene glycol, polycaprolactone, polytetramethylene ether and/or a combination; the cover of the composite structure may comprise a surface layer; the surface layer may comprise a thickness of between 0.1 and 1.5 mm; the surface layer may comprise a hardness of 20-60 D; the surface layer may comprise a density of 1000-1200 kg/m; the cover of the composite structure may comprise a coating; the coating may be formed by an aqueous polyurethane system and/or an acrylic system; the weight of the coating may be between 0.05 and 0.2 percent of total weight of the composite structure; the coating may have a thickness of between 2 and 50 m; the base of the composite structure may comprise a foam layer; the foam layer may be formed from a material comprising a thermoplastic polyester elastomer by a foaming process; the intermediate layer of the composite structure may comprise a first foam layer and/or a second foam layer; the thickness of the first foam layer may be between 0.1 and 1 mm; the first foam layer may comprise a density of 100-300 kg/m; the second foam layer may comprise a thickness of between 1 and 10 mm; the second foam layer may comprise a density of between 50 and 150 kg/m; the composite structure may comprise a fabric layer; the fabric layer may be formed of fibers comprising a thermoplastic polyester material; the fibers may comprise thermoplastic polyester fibers and/or thermoplastic polyester elastomer fibers; the fabric layer may comprise polybutylene terephthalate fiber and/or thermoplastic copolyester elastomer fiber; the material of construction of the composite structure comprising the thermoplastic polyester material may comprise more than 70 percent of total weight of the composite structure; the material of construction of the composite structure comprising the thermoplastic polyester material may comprise more than 85 percent of total weight of the composite structure; the material of construction of the composite structure comprising a thermoplastic polyester elastomer may comprise more than 60 percent of total weight of the composite structure; the material of construction of the composite structure comprising a thermoplastic polyester elastomer may comprise more than 85 percent of total weight of the composite structure; the composite structure may comprise the cover layer comprising a surface layer and a fabric layer and a first foam layer; the cover layer may comprise a surface layer and the intermediate layer may comprise a fabric layer and the base may comprise a first foam layer; the intermediate layer may comprise the first foam layer; the base may comprise the fabric layer; the fabric layer and the first foam layer may be beneath the surface layer; a second foam layer may be between the surface layer and the fabric layer; the composite structure may comprise a cover comprising a surface layer and intermediate layer comprising a first foam layer and a fabric layer and the base comprising a second foam layer; the composite structure may comprise the cover comprising a surface layer and an intermediate layer comprising a fabric layer and a base comprising a first foam layer and a second foam layer; the cover of the composite structure may comprise a surface layer formed from a thermoplastic copolyester elastomer by means of a calendering and/or tape casting; the thermoplastic copolyester elastomer forming the surface layer may comprise a hard segment and a soft segment; the thermoplastic copolyester elastomer may comprise properties at the surface layer comprising resistance to stretch tearing, comfort, soft touch, wear resistance, durability, etc.; the composite structure may comprise at least one generally rigid segment and at least one generally compressible segment; the generally compressible segment may comprise a foam material; the ratio of the generally rigid segment of the thermoplastic copolymer elastomer may comprise from between 25 to 60 percent of total thermoplastic copolymer elastomer; the ratio of the generally compressible segment of the copolymer elastomer may comprise from between 40 to 75 percent of total copolymer elastomer; the copolymer elastomer may comprise a thermoplastic copolyester elastomer; the thermoplastic copolyester elastomer may comprise at least 90 percent of the composite structure by weight; the material of construction for the composite structure may comprise additives; additives may comprise a colorant and/or an antioxidant; the material of construction may comprise resin; the material of construction may not comprise resin; requirements for mechanical properties at the cover of composite structure may comprise tactile sensation, durability in use, thickness, hardness, density, etc.; the cover may comprise a surface layer configured to enhance performance to meet requirements.

The present invention relates to a method of recovering materials of construction of a composite structure of a component for a vehicle interior to facilitate recycling and reuse of materials of construction at end of life of the component may comprise the steps of providing the component as an assembly comprising the composite structure and a frame, separating the composite structure as a unit from the frame by disassembly, shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure; the composite structure as a unit may comprise a cover and an intermediate layer and a base; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the mechanical process may comprise shredding; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the composite structure as a unit may comprise a cover and an intermediate layer and a base; the family of polymer materials of materials of construction of the composite structure may comprise a mono-material family of polymer materials selected to be recovered to facilitate recycling and reuse after shredding the composite structure as a unit; the cover may comprise a skin comprising a polymer material formed to provide an exterior surface comprising a decorative effect for the composite structure of the component; the intermediate layer may comprise at least two layers of recyclable material between the cover and the base; the base of the composite structure may comprise a foam material; the frame of the assembly of the component may comprise a metal material; the frame of the assembly may comprise at least one mechanism.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIGS. 2A through 2C are schematic perspective views of a seat for a vehicle interior according to an exemplary embodiment.

FIG. 3A is a schematic perspective view of a component for a vehicle interior according to an exemplary embodiment.

FIG. 3B is a schematic perspective section view of a component for a vehicle interior according to an exemplary embodiment.

FIG. 4A is a schematic perspective view of a component for a vehicle interior according to an exemplary embodiment.

FIG. 4B is a schematic perspective section view of a component for a vehicle interior according to an exemplary embodiment.

FIG. 5A is a schematic perspective view of a seat for a vehicle interior according to an exemplary embodiment.

FIG. 5B is a schematic perspective section view of a component for a vehicle interior according to an exemplary embodiment.

FIG. 6A is a schematic perspective view of a component for a vehicle interior according to an exemplary embodiment.

FIG. 6B is a schematic perspective section view of a component for a vehicle interior according to an exemplary embodiment.

FIG. 6C is a schematic perspective view of a component for a vehicle interior according to an exemplary embodiment.

FIG. 6D is a schematic perspective section view of a component for a vehicle interior according to an exemplary embodiment.

FIG. 6E is a schematic perspective view of a component for a vehicle interior according to an exemplary embodiment.

FIG. 6F is a schematic side elevation section view of a component for a vehicle interior according to an exemplary embodiment.

FIG. 7A is a schematic perspective view of a component for a vehicle interior according to an exemplary embodiment.

FIG. 7B is a schematic perspective section view of a component for a vehicle interior according to an exemplary embodiment.

FIG. 7C is a schematic perspective view of a component for a vehicle interior according to an exemplary embodiment.

FIGS. 7D through 7F are schematic perspective section views of a component for a vehicle interior according to an exemplary embodiment.

FIG. 8A is a schematic perspective view of a component for a vehicle interior according to an exemplary embodiment.

FIG. 8B is a schematic perspective section view of a component for a vehicle interior according to an exemplary embodiment.

FIG. 9A is a schematic perspective view of a component for a vehicle interior according to an exemplary embodiment.

FIG. 9B is a schematic perspective section view of a component for a vehicle interior according to an exemplary embodiment.

FIGS. 10A through 10F are schematic perspective section views of a component for a vehicle interior according to an exemplary embodiment.

FIGS. 11 and 11A are schematic side elevation section views of a composite structure for a vehicle interior according to an exemplary embodiment.

FIGS. 12 and 12A are schematic side elevation section views of a composite structure for a vehicle interior according to an exemplary embodiment.

FIGS. 13 and 13A are schematic side elevation section views of a composite structure for a vehicle interior according to an exemplary embodiment.

FIGS. 14 and 14A are schematic side elevation section views of a composite structure for a vehicle interior according to an exemplary embodiment.

FIGS. 15 and 15A are schematic side elevation section views of a composite structure for a vehicle interior according to an exemplary embodiment.

FIGS. 16 and 16A are schematic side elevation section views of a composite structure for a vehicle interior according to an exemplary embodiment.

FIGS. 17 and 17A are schematic side elevation section views of a composite structure for a vehicle interior according to an exemplary embodiment.

FIGS. 18 and 18A are schematic side elevation section views of a composite structure for a vehicle interior according to an exemplary embodiment.

FIGS. 19 and 19A are schematic side elevation section views of a composite structure for a vehicle interior according to an exemplary embodiment.

FIGS. 20 and 20A are schematic side elevation section views of a composite structure for a vehicle interior according to an exemplary embodiment.

FIGS. 21 and 21A are schematic side elevation section views of a composite structure for a vehicle interior according to an exemplary embodiment.

FIGS. 22 and 22A are schematic side elevation section views of a composite structure for a vehicle interior according to an exemplary embodiment.

FIGS. 23 and 23A are schematic side elevation section views of a composite structure for a vehicle interior according to an exemplary embodiment.

FIGS. 24 and 24A are schematic side elevation section views of a composite structure for a vehicle interior according to an exemplary embodiment.

FIG. 25 is a schematic diagram of system diagram of a system and method of recycling and recovery for reuse of materials of construction of a composite structure of an assembly of a component for a vehicle interior according to an exemplary embodiment.

### DESCRIPTION

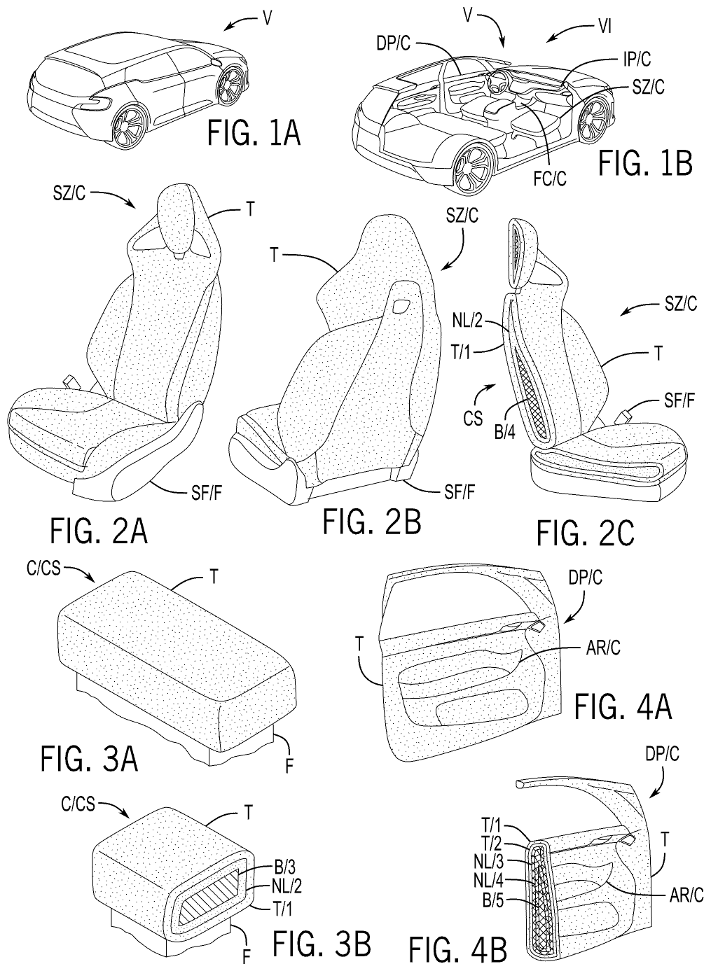

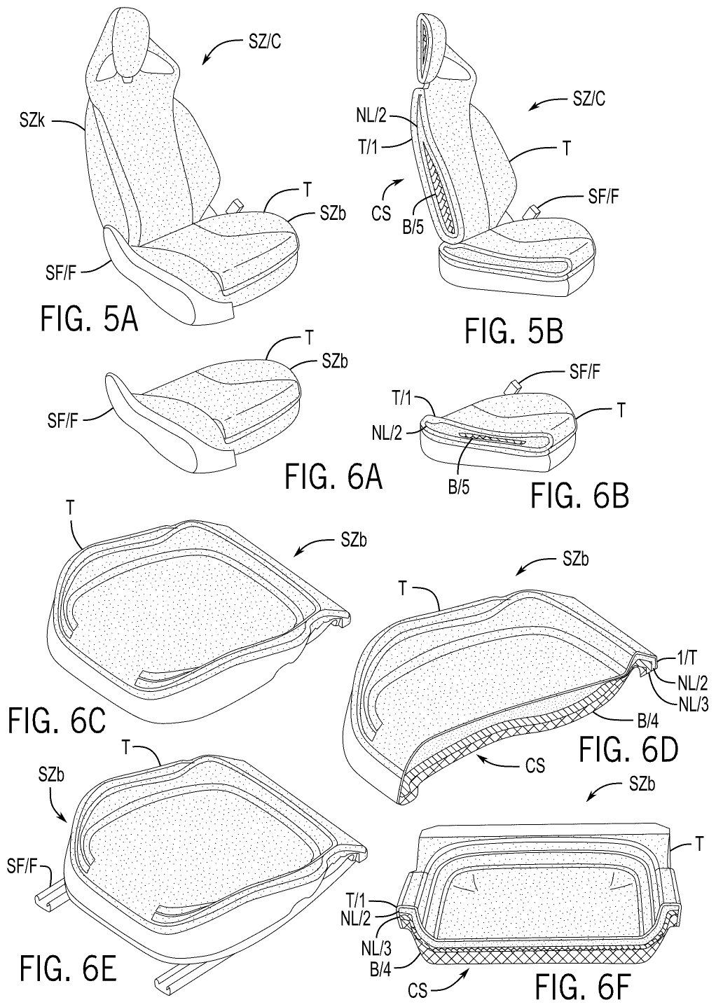

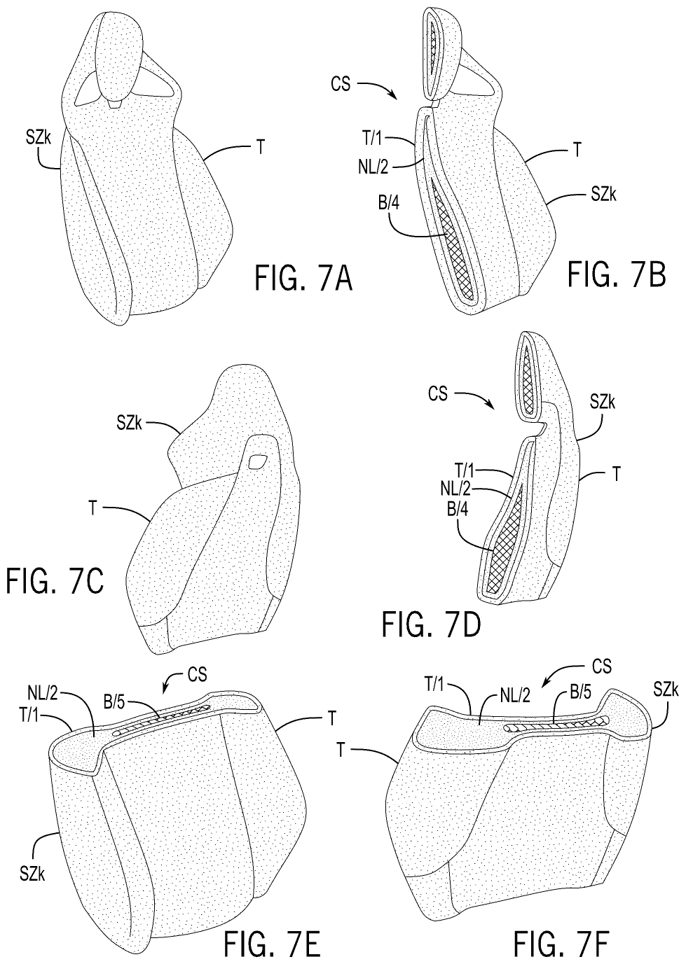

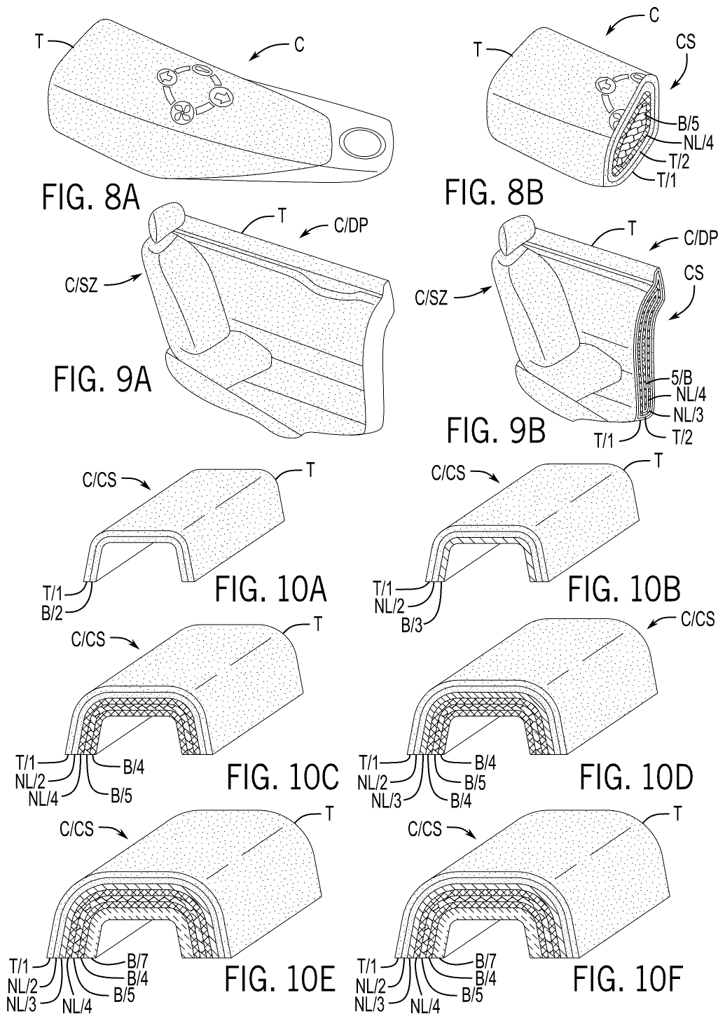

Referring to FIGS. 1A-1B, a vehicle V comprising a vehicle interior VI is shown comprising components C such as an instrument panel IP, door panel DP, console shown as floor/center console FC, seat assembly SZ, etc.; the component C may comprise a composite structure CS comprising material of construction including a cover T and a base B and an intermediate layer NL; component C may comprise an assembly may comprise a frame F and the composite structure CS; the composite structure CS may be formed on the frame F; and the frame may comprise a metal material. See also FIGS. 2A-2C, 3A-3B, 4A-4B, 5A-5B, 6A-6F, 7A-7F, 8A-8B, 9A-9B and 10A-10F.

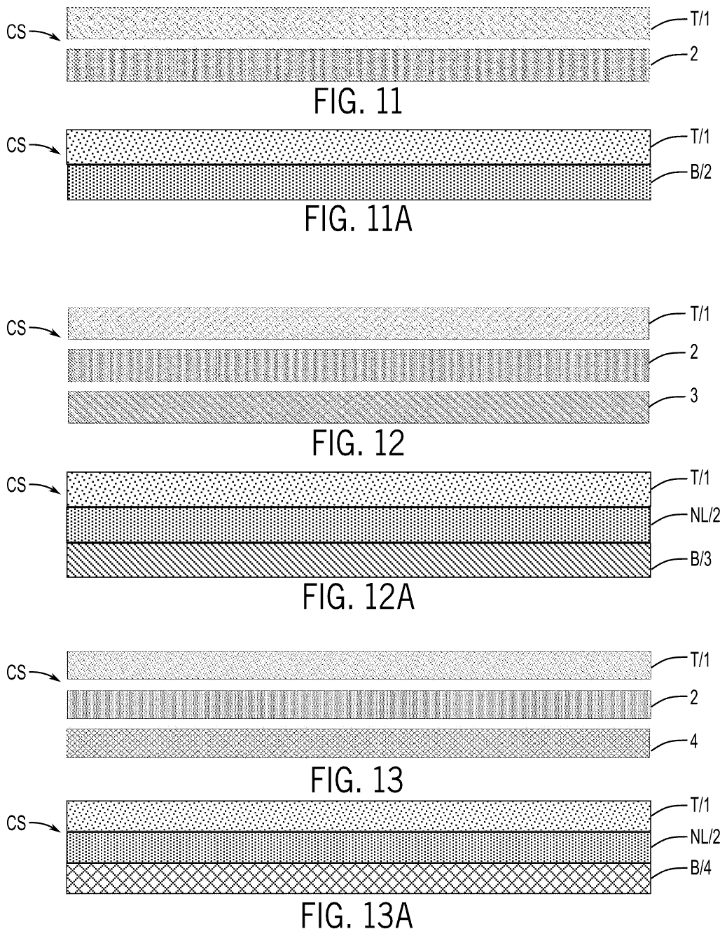

According to an exemplary embodiment as shown schematically in FIGS. 2A-2C, 3A-3B, 4A-4B, 5A-5B, 6A-6F, 7A-7F, 8A-8B, 9A-9B, 10A-10F and 25, a component C for a vehicle interior VI may be configured to facilitate recycling and reuse of material of construction at end of life; the component C may comprise an assembly comprising a composite structure CS; the composite structure CS as a unit may comprise a cover T and a base B; the composite structure as the unit may comprise material of construction; material of construction for the composite structure as the unit comprise recyclable materials; the assembly may be configured to be disassembled to facilitate recycling and reuse of material of construction of the composite structure as the unit. See also FIGS. 11A-11B, 12-12A. 13-13A, 14-14A, 15-15A, 16-16A, 17-17A, 18-18A, 19-19A, 20-20A, 21-21A, 22-22A, 23-23A and 24-24A. As indicated schematically, the assembly may comprise a frame F; the composite structure may be formed on the frame; and the frame may comprise a metal material (including frame structure, mechanism, etc.).

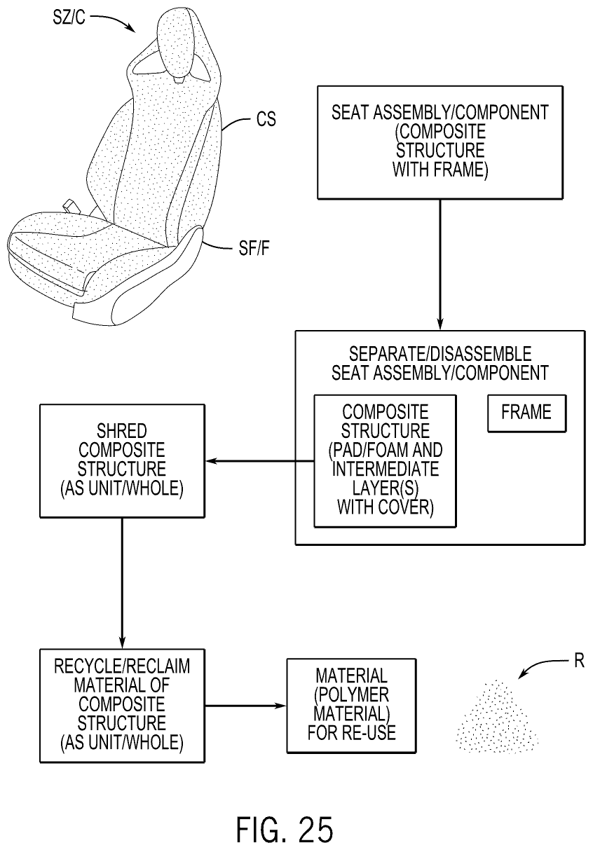

As indicated schematically in FIGS. 12-12A. 13-13A, 14-14A, 15-15A, 16-16A, 17-17A, 18-18A, 19-19A, 20-20A, 21-21A, 22-22A, 23-23A and 24-24A, the composite structure CS as the unit may comprise an intermediate layer NL between the cover T and the base B. As indicated schematically in FIG. 25, the assembly may be configured to be disassembled to facilitate recovery of material of construction of the composite structure as the unit by separation of the composite structure as the unit from the frame and reducing of the composite structure as the unit by a mechanical process for reclaiming and recovery of material of construction; the mechanical process may comprise shredding.

As indicated schematically in FIGS. 2A-2C, 5A-5B, 6A-6F and 7A-7F, component C comprising the assembly may comprise a seat assembly SZ/C; the seat assembly SZ may comprise a seat back SZk comprising the composite structure CS and a frame SF/F and a seat cushion SZc comprising the composite structure CS and a frame SF/F; the composite structure CS for the assembly of seat assembly SZ may comprise materials of construction configured for recovery/recycling after separation from frame SF/F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

As indicated schematically in FIGS. 3A-3B and 10A-10F, component C comprising the assembly may comprise a trim component such as a console shown as floor/center console FC; the assembly of console FC may comprise a frame F; the composite structure CS for the assembly of console FC may comprise materials of construction configured for recovery/recycling after separation from frame F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

As indicated schematically in FIGS. 4A-4B and 8A-8B and 9A-9B, component C comprising the assembly may comprise a trim component such as a door panel DP with armrest AR; the assembly of component C may comprise a frame F; the composite structure CS for the component C may comprise materials of construction configured for recovery/recycling after separation from frame F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

According to an exemplary embodiment as shown schematically in FIGS. 2A-2C, 3A-3B, 4A-4B, 5A-5B, 6A-6F, 7A-7F, 8A-8B, 9A-9B, 10A-10F and 25, the composite structure CS for the assembly/component C may comprise the cover T comprising a surface layer 1/2 and/or an intermediate layer NL comprising a first foam layer 5 and a fabric layer 4 and/or the base B comprising a second foam layer 5; as indicated schematically, the intermediate layer NL may comprise at least two layers of recyclable material comprising a fabric material 4 and a foam material 5 providing a generally compressible segment between the cover T comprising a surface layer 1/2 and the base B comprising a foam material 5 and/or fabric material 4, etc. See also FIGS. 12-12A. 13-13A, 14-14A, 15-15A, 16-16A, 17-17A, 18-18A, 19-19A, 20-20A, 21-21A, 22-22A, 23-23A, 24-24A and 25.

As indicated schematically in FIGS. 2A-2C, 3A-3B, 4A-4B, 5A-5B, 6A-6F, 7A-7F, 8A-8B, 9A-9B, 10A-10F and 25, the assembly of the component C comprising the composite structure CS and frame F may be configured to be disassembled to facilitate recovery of material of construction of the composite structure as the unit by separation of the composite structure as the unit from the frame and reducing of the composite structure as the unit by a mechanical process for reclaiming and recovery of material of construction. The mechanical process may comprise shredding. The cover may comprise a skin layer comprising a polymer material comprising a generally rigid segment formed to provide an exterior surface comprising a decorative effect for the composite structure. Material of construction of the composite structure may comprise a polymer material selected from a group of polymer materials comprising (a) a polyolefin group; (b) a thermoplastic elastomeric group; (c) an elastomeric group; (d) thermoplastic copolymer elastomer; (e) thermoplastic copolyester elastomer; (f) thermoplastic polymer; (g) polymer material; (h) resin material. The group of polymer materials of material of construction for the composite structure as a unit may comprise a mono-material for recyclability; the mono-material may comprise a single material group. Material of construction of the composite structure may comprise a thermoplastic polyester material comprising more than 70 percent of total weight of the composite structure. The composite structure may be configured to provide a surface effect at the cover; the surface effect may comprise at least one of (a) softness; (b) compressibility, (c) elastic deformability; (d) resilience; (e) decorative appearance; (f) visual effect; (g) durability. The base of the composite structure may comprise a foam material; the base of the composite structure may comprise a fabric layer. The composite structure may comprise a generally rigid segment and a generally compressible segment. Ratio of a generally rigid segment of the thermoplastic polymer of the composite structure may comprise from between 25 to 60 percent of total thermoplastic polymer; ratio of a generally compressible segment of the thermoplastic polymer of the composite structure may comprise from between 40 to 75 percent of total thermoplastic polymer.

As indicated schematically in FIG. 25, a method of recovering materials of construction of a composite structure of a component for a vehicle interior to facilitate recycling and reuse of materials of construction at end of life of the component may comprise the steps of: providing the component as an assembly comprising the composite structure and a frame and separating the composite structure as a unit from the frame by disassembly and shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure. The composite structure as a unit may comprise a cover and an intermediate layer and a base; the composite structure as a unit may be configured to be disassembled from the frame to facilitate recovery of materials of construction of the composite structure as the unit by separation of the composite structure as the unit from the frame and reducing of the composite structure as the unit by a mechanical process for reclaiming and recovery of materials of construction. Material of construction for the composite structure may comprise additives; additives may comprise a colorant and/or an antioxidant.

As indicated schematically in FIGS. 2A-2C, 3A-3B, 4A-4B, 5A-5B, 6A-6F, 7A-7F, 8A-8B, 9A-9B, 10A-10F and 25, a component for a vehicle interior configured to facilitate recycling material of construction at end of life may comprise an assembly comprising a composite structure comprising a cover and an intermediate layer and a base; material of construction for the composite structure as a whole/unit may comprise of recyclable materials selected from a group of polymer materials comprising a mono-material/single-material group, such as a thermoplastic polymer/copolyester elastomer group. The composite structure may comprise the cover comprising a surface layer as a rigid segment and an intermediate layer comprising a foam layer and/or a fabric layer and the base comprising a foam layer providing a compressible segment. As indicated schematically in FIG. 25, a method of recovering materials of construction of the composite structure substantially as the whole/unit for reuse may comprise the step of disassembly of the composite structure of the assembly from the frame of the assembly to facilitate efficient recovery/reuse of materials of construction of the composite structure as a whole/unit by mechanical separation/shredding.

### Exemplary Embodiments—A

According to an exemplary embodiment as shown schematically in FIGS. 2A-2C, 3A-3B, 4A-4B, 5A-5B, 6A-6F, 7A-7F, 8A-8B, 9A-9B, 10A-10F and 25, a component C for a vehicle interior VI configured to facilitate recycling and reuse of material of construction at end of life may comprise an assembly comprising a composite structure CS; the composite structure CS as a unit may comprise a cover T and a base B; the composite structure as the unit may comprise material of construction; material of construction for the composite structure as the unit comprise recyclable materials; the assembly may be configured to be disassembled to facilitate recycling and reuse of material of construction of the composite structure as the unit. See also FIGS. 11A-11B, 12-12A. 13-13A, 14-14A, 15-15A, 16-16A, 17-17A, 18-18A, 19-19A, 20-20A, 21-21A, 22-22A, 23-23A and 24-24A. As indicated schematically, the assembly may comprise a frame F; the composite structure may be formed on the frame; and the frame may comprise a metal material (including frame structure, mechanism, etc.). As indicated schematically in FIGS. 12-12A. 13-13A, 14-14A, 15-15A, 16-16A, 17-17A, 18-18A, 19-19A, 20-20A, 21-21A, 22-22A, 23-23A and 24-24A, the composite structure CS as the unit may comprise an intermediate layer NL between the cover T and the base B. As indicated schematically in FIG. 25, the assembly may be configured to be disassembled to facilitate recovery of material of construction of the composite structure as the unit by separation of the composite structure as the unit from the frame and reducing of the composite structure as the unit by a mechanical process for reclaiming and recovery of material of construction; the mechanical process may comprise shredding.

As indicated schematically in FIGS. 2A-2C, 5A-5B, 6A-6F and 7A-7F, component C comprising the assembly may comprise a seat assembly SZ/C; the seat assembly SZ may comprise a seat back SZk comprising the composite structure CS and a frame SF/F and a seat cushion SZc comprising the composite structure CS and a frame SF/F; the composite structure CS for the assembly of seat assembly SZ may comprise materials of construction configured for recovery/recycling after separation from frame SF/F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

As indicated schematically in FIGS. 3A-3B and 10A-10F, component C comprising the assembly may comprise a trim component such as a console shown as floor/center console FC; the assembly of console FC may comprise a frame F; the composite structure CS for the assembly of console FC may comprise materials of construction configured for recovery/recycling after separation from frame F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

As indicated schematically in FIGS. 4A-4B and 8A-8B and 9A-9B, component C comprising the assembly may comprise a trim component such as a door panel DP with armrest AR; the assembly of component C may comprise a frame F; the composite structure CS for the component C may comprise materials of construction configured for recovery/recycling after separation from frame F. See FIGS. 12-12A. 13-13A, 14-14A, 15-15A, 16-16A, 17-17A, 18-18A, 19-19A, 20-20A, 21-21A, 22-22A, 23-23A, 24-24A and 25.

According to an exemplary embodiment as shown schematically in FIGS. 2A-2C, 3A-3B, 4A-4B, 5A-5B, 6A-6F, 7A-7F, 8A-8B, 9A-9B, 10A-10F and 25, the composite structure CS for the assembly/component C may comprise (a) the cover T comprising a surface layer 1/2 and/or (b) an intermediate layer NL comprising a first foam layer 5 and a fabric layer 4 and/or (c) the base B comprising a second foam layer 5; as indicated schematically, the intermediate layer NL may comprise at least two layers of recyclable material comprising a fabric material 4 and a foam material 5 providing a generally compressible segment between the cover T comprising a surface layer 1/2 and the base B comprising a foam material 5 and/or fabric material 4, etc. See also FIGS. 12-12A. 13-13A, 14-14A, 15-15A, 16-16A, 17-17A, 18-18A, 19-19A, 20-20A, 21-21A, 22-22A, 23-23A, 24-24A and 25. Material of construction for the composite structure may comprise additives; additives may comprise a colorant and/or an antioxidant.

As indicated schematically in FIGS. 12-12A. 13-13A, 14-14A, 15-15A, 16-16A, 17-17A, 18-18A, 19-19A, 20-20A, 21-21A, 22-22A, 23-23A and 24-24A, the cover T of the composite structure CS may comprise a skin layer comprising a polymer material comprising a generally rigid segment formed to provide an exterior surface comprising a decorative effect for the composite structure. Material of construction of the composite structure may comprise a polymer material selected from a group of polymer materials comprising (a) a polyolefin group; (b) a thermoplastic elastomeric group; (c) an elastomeric group; (d) thermoplastic copolymer elastomer; (e) thermoplastic copolyester elastomer; (f) thermoplastic polymer; (g) polymer material; (h) resin material. The group of polymer materials of material of construction for the composite structure as a unit may comprise a mono-material for recyclability; the mono-material may comprise a single material group. Material of construction of the composite structure may comprise a thermoplastic polyester material comprising more than 70 percent of total weight of the composite structure. The composite structure may be configured to provide a surface effect at the cover; the surface effect may comprise at least one of (a) softness; (b) compressibility, (c) elastic deformability; (d) resilience; (e) decorative appearance; (f) visual effect; (g) durability. The base of the composite structure may comprise a foam material; the base of the composite structure may comprise a fabric layer. The composite structure may comprise a generally rigid segment and a generally compressible segment. Ratio of a generally rigid segment of the thermoplastic polymer of the composite structure may comprise from between 25 to 60 percent of total thermoplastic polymer; ratio of a generally compressible segment of the thermoplastic polymer of the composite structure may comprise from between 40 to 75 percent of total thermoplastic polymer. The composite structure may comprise (a) the cover comprising a surface layer and (b) an intermediate layer comprising a first foam layer and a fabric layer and (c) the base comprising a second foam layer. The intermediate layer may comprise at least two layers of recyclable material comprising a fabric material and a foam material providing a generally compressible segment between the cover and the base. Material of construction for the composite structure may comprise additives; additives may comprise a colorant and/or an antioxidant.

According to an exemplary embodiment as indicated schematically in FIGS. 12-12A. 13-13A, 14-14A, 15-15A, 16-16A, 17-17A, 18-18A, 19-19A, 20-20A, 21-21A, 22-22A, 23-23A, 24-24A and 25, a method of recovering materials of construction of a composite structure of a component for a vehicle interior to facilitate recycling and reuse of materials of construction at end of life of the component; the method may comprise the steps of: providing the component as an assembly comprising the composite structure and a frame and separating the composite structure as a unit from the frame by disassembly and shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure. The composite structure as a unit may comprise a cover and an intermediate layer and a base; the composite structure as a unit may be configured to be disassembled from the frame to facilitate recovery of materials of construction of the composite structure as the unit by separation of the composite structure as the unit from the frame and reducing of the composite structure as the unit by a mechanical process for reclaiming and recovery of materials of construction. Material of construction for the composite structure may comprise additives; additives may comprise a colorant and/or an antioxidant.

According to an exemplary embodiment as shown schematically in the FIGURES, a component for a vehicle interior configured to facilitate recycling and reuse of materials of construction at end of life may comprise an assembly comprising a composite structure; the composite structure as a unit may comprise a cover and an intermediate layer and a base; the composite structure as the unit may comprise materials of construction; materials of construction for the composite structure as the unit may comprise recyclable materials; the assembly may be configured to be disassembled to facilitate recycling and reuse of materials of construction of the composite structure as the unit; materials of construction for the composite structure may consist essentially of recyclable materials; materials of construction may be selected from a family of polymer materials; materials of construction of the composite structure as the unit comprising the cover and the intermediate layer and the base may be selected from a family of polymer materials; materials of construction for the cover and the intermediate layer and the base may be selected from a mono-material family of polymer materials. The assembly may comprise a frame; the composite structure may be provided on the frame; the composite structure may be formed on the frame; the frame may comprise a metal material; the assembly may be configured to be disassembled to facilitate recycling and reuse of materials of construction of the composite structure as the unit by separation of the composite structure as the unit from the frame; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the mechanical process may comprise shredding; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may comprise a seat assembly; the seat assembly may comprise a seat back and a seat cushion; the seat assembly may comprise a frame; the frame may comprise at least one mechanism; the frame may comprise a metal material; the composite structure may be formed on the frame; the composite structure may be removable from the frame at end of life; the assembly may comprise a console; the assembly may comprise a trim panel; the assembly may comprise a door panel; the assembly may comprise an instrument panel; the base may comprise a foam material; the intermediate layer may comprise a set of intermediate layers; the cover may comprise a skin and/or skin layer; the composite structure as a unit may comprise a cover and an intermediate layer and a base; the family of polymer materials of materials of construction of the composite structure may comprise a mono-material family of polymer materials selected to be recovered to facilitate recycling and reuse after shredding the composite structure as a unit; the cover may comprise a skin comprising a polymer material formed to provide an exterior surface comprising a decorative effect for the composite structure of the component; the intermediate layer may comprise at least two layers of recyclable material between the cover and the base; the base of the composite structure may comprise a foam material; the frame of the assembly of the component may comprise a metal material; materials of construction for the cover, the pad and the base may comprise a polymer material configured for recyclability and reuse after reduction by a mechanical process; the polymer material may be selected from a group of polymer materials comprising a polyolefin group, a thermoplastic elastomeric group and/or an elastomeric group; the group of polymer materials of materials of construction for the composite structure as a unit may comprise a mono-material for recyclability; the mono-material may comprise a single material group; the composite structure as the unit may comprise a sub-assembly; the composite structure may be configured to provide a surface effect at the cover; the surface effect may comprise at least one of softness, compressibility, elastic deformability, resilience, decorative appearance, visual effect, durability, etc.; the material of construction for the composite structure may comprise a material comprising a thermoplastic copolyester elastomer by calendering and/or casting; the thermoplastic copolyester elastomer forming the composite structure may comprise a generally rigid segment and a generally compressible segment; the generally rigid segment may comprise a hard segment and the generally compressible segment may comprise a soft segment; the generally rigid segment of the thermoplastic copolyester elastomer may comprise at least one of poly (butylene terephthalate), poly (ethylene terephthalate), poly (trimethylene terephthalate), poly (trimethylene terephthalate)/poly (butylene terephthalate), poly (2,6-naphthalate), poly (trimethylene terephthalate), poly (ethylene terephthalate)/polybutylene terephthalate copolymers, poly (dimethyl terephthalate/m-xylylene)/1,4-butanediol copolymers, poly (2,5-furan dicarboxylate), poly (2,5-furandicarboxylic acid) propylene glycol ester, poly (2,5-furandicarboxylate), poly (2,5-furan dicarboxylate) and/or a combination; the generally compressible segment of the thermoplastic copolyester elastomer may comprise at least one of polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide and/or a combination, preferably, polyethylene glycol, polycaprolactone, polytetramethylene ether and/or a combination; the cover of the composite structure may comprise a surface layer; the surface layer may comprise a thickness of between 0.1 and 1.5 mm; the surface layer may comprise a hardness of 20-60 D; the surface layer may comprise a density of 1000-1200 kg/m; the cover of the composite structure may comprise a coating; the coating may be formed by an aqueous polyurethane system and/or an acrylic system; the weight of the coating may be between 0.05 and 0.2 percent of total weight of the composite structure; the coating may have a thickness of between 2 and 50 m; the base of the composite structure may comprise a foam layer; the foam layer may be formed from a material comprising a thermoplastic polyester elastomer by a foaming process; the intermediate layer of the composite structure may comprise a first foam layer and/or a second foam layer; the thickness of the first foam layer may be between 0.1 and 1 mm; the first foam layer may comprise a density of 100-300 kg/m; the second foam layer may comprise a thickness of between 1 and 10 mm; the second foam layer may comprise a density of between 50 and 150 kg/m; the composite structure may comprise a fabric layer; the fabric layer may be formed of fibers comprising a thermoplastic polyester material; the fibers may comprise thermoplastic polyester fibers and/or thermoplastic polyester elastomer fibers; the fabric layer may comprise polybutylene terephthalate fiber and/or thermoplastic copolyester elastomer fiber; the material of construction of the composite structure comprising the thermoplastic polyester material may comprise more than 70 percent of total weight of the composite structure; the material of construction of the composite structure comprising the thermoplastic polyester material may comprise more than 85 percent of total weight of the composite structure; the material of construction of the composite structure comprising a thermoplastic polyester elastomer may comprise more than 60 percent of total weight of the composite structure; the material of construction of the composite structure comprising a thermoplastic polyester elastomer may comprise more than 85 percent of total weight of the composite structure; the composite structure may comprise the cover layer comprising a surface layer and a fabric layer and a first foam layer; the cover layer may comprise a surface layer and the intermediate layer may comprise a fabric layer and the base may comprise a first foam layer; the intermediate layer may comprise the first foam layer; the base may comprise the fabric layer; the fabric layer and the first foam layer may be beneath the surface layer; a second foam layer may be between the surface layer and the fabric layer; the composite structure may comprise a cover comprising a surface layer and intermediate layer comprising a first foam layer and a fabric layer and the base comprising a second foam layer; the composite structure may comprise the cover comprising a surface layer and an intermediate layer comprising a fabric layer and a base comprising a first foam layer and a second foam layer; the cover of the composite structure may comprise a surface layer formed from a thermoplastic copolyester elastomer by means of a calendering and/or tape casting; the thermoplastic copolyester elastomer forming the surface layer may comprise a hard segment and a soft segment; the thermoplastic copolyester elastomer may comprise properties at the surface layer comprising resistance to stretch tearing, comfort, soft touch, wear resistance, durability, etc.; the composite structure may comprise at least one generally rigid segment and at least one generally compressible segment; the generally compressible segment may comprise a foam material; the ratio of the generally rigid segment of the thermoplastic copolymer elastomer may comprise from between 25 to 60 percent of total thermoplastic copolymer elastomer; the ratio of the generally compressible segment of the copolymer elastomer may comprise from between 40 to 75 percent of total copolymer elastomer; the copolymer elastomer may comprise a thermoplastic copolyester elastomer; the thermoplastic copolyester elastomer may comprise at least 90 percent of the composite structure by weight; the material of construction for the composite structure may comprise additives; additives may comprise a colorant and/or an antioxidant; the material of construction may comprise resin; the material of construction may not comprise resin; requirements for mechanical properties at the cover of composite structure may comprise tactile sensation, durability in use, thickness, hardness, density, etc.; the cover may comprise a surface layer configured to enhance performance to meet requirements.

According to an exemplary embodiment as shown schematically in the FIGURES, a method of recovering materials of construction of a composite structure of a component for a vehicle interior to facilitate recycling and reuse of materials of construction at end of life of the component may comprise the steps of providing the component as an assembly comprising the composite structure and a frame, separating the composite structure as a unit from the frame by disassembly, shredding the composite structure as the unit to reduce materials of construction of the composite structure substantially as a whole and reclaiming materials of construction of the composite structure substantially as the whole for reuse; materials of construction for the composite structure may consist essentially of recyclable materials selected from a family of polymer materials; the assembly may be configured to be disassembled to facilitate recycling and reuse of materials of construction of the composite structure; the composite structure as a unit may comprise a cover and an intermediate layer and a base; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the assembly may be configured to be disassembled to facilitate recovery of materials of construction of the composite structure as the unit by separation of the composite structure as the unit from the frame and reducing of the composite structure as the unit by a mechanical process for reclaiming and recovery of materials of construction; the mechanical process may comprise shredding; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the assembly may be configured to be disassembled to facilitate recovery of materials of construction of the composite structure as the unit by separation of the composite structure as the unit from the frame and reducing of the composite structure as the unit by shredding for reclaiming and recovery of materials of construction; the composite structure as a unit may comprise a cover and an intermediate layer and a base; the family of polymer materials of materials of construction of the composite structure may comprise a mono-material family of polymer materials selected to be recovered to facilitate recycling and reuse after shredding the composite structure as a unit; the cover may comprise a skin comprising a polymer material formed to provide an exterior surface comprising a decorative effect for the composite structure of the component; the intermediate layer may comprise at least two layers of recyclable material between the cover and the base; the base of the composite structure may comprise a foam material; the frame of the assembly of the component may comprise a metal material; the frame of the assembly may comprise at least one mechanism.

### Exemplary Embodiments—B

According to an exemplary embodiment as shown schematically in the FIGURES, a composite structure for an interior component of a vehicle may comprise a multi-layer structure; the selection/structure of each layer (such as the material, hardness, thickness, relative positional relationship, etc. of each layer) contained in the composite structure may be configured so that the composite structure provides improved properties and is environmentally friendly and able to provide performance suitable for use in a vehicle interior. As indicated schematically, a composite structure comprising a cover/skin layer may be used for an interior component, such as an instrument panel, a door panel, a center console, an armrest, a seat assembly, etc.; the composite structure may comprise a skin layer. The composite structure may comprise a cover/coating on one side of the skin layer. The composite structure may also include other layers such as a foam layer, a fabric layer, etc.; suitable material, layers, skin layers, etc. as material of construction may impart desirable properties to the component including suitable color rendering, good tactile feel, excellent mechanical strength and wear resistance, etc. The skin layer may be formed from a material comprising a thermoplastic copolyester elastomer (TPC).

Thermoplastic copolyester elastomers are a class of recyclable thermoplastic materials that have excellent properties such as excellent mechanical strength, good tear resistance and wear resistance, chemical corrosion resistance, ease of processing, excellent resilience suitable for coating materials for automotive interior components.

Thermoplastic copolyester elastomer material may include hard segments (typically polyester segments) and soft segments (typically polyester segments or polyether segments). As indicates schematically, a “hard segment” (generally rigid) refers from a material with a high melting point block that may be crystallized and repeated in the block copolymer; a “soft segment” (generally compressible) refers from a material of an amorphous block having a relatively low glass transition temperature in the block copolymer. Suitable hard segments and soft segments in the thermoplastic copolyester elastomer may impart superior properties to the surface layer: such as stretch tearing, comfort, soft touch, wear resistance, etc. The hard segment of the thermoplastic copolyester elastomer forming the skin layer may comprise Polybutylene terephthalate, polyethylene terephthalate, poly (trimethylene terephthalate), poly (ethylene terephthalate)-1,4-dimethylene cyclohexane, poly (2,6-naphthalate), xylene terephthalate, polyethylene terephthalate/polybutylene terephthalate copolymers, poly (dimethyl terephthalate/isophthalate/1,4-butanediol) copolymers, poly (2,5-furan dicarboxylate), poly (2,5-furandicarboxylic acid) propylene glycol ester, poly (2,5-furandicarboxylate), poly (2,5-furandicolinate) and/or a combination. Preferably, the hard segment of the thermoplastic copolyester elastomer forming the skin layer may comprise polybutylene terephthalate, poly2,5-furandicarboxylic acid butylene glycol ester and/or a combination. The soft segment of the thermoplastic copolyester elastomer forming the skin layer may comprise polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide and/or a combination. Preferably, the soft segment of the thermoplastic copolyester elastomer forming the skin layer may comprise polyethylene glycol, polycaprolactone, polytetramethylene ether and/or a combination.

The proportion of soft segments and hard segments in the thermoplastic copolyester elastomer may be within a suitable range to impart good performance to the formed surface layer. In the thermoplastic copolyester elastomer, a molar ratio of the hard segment to the entire copolyester elastomer ranges from 25 percent to 60 percent, preferably 30 percent to 40 percent; and the soft section accounts for 40 percent to 75 percent, preferably 60 percent to 70 percent, of the total copolyester elastomer.

As indicated schematically, a higher molecular weight thermoplastic copolyester elastomer is preferably used to form the composite structure with cover/skin layer, which facilitates optimization of the surface properties. The thermoplastic copolyester elastomer may have a molecular weight of 20000 to 40000, preferably 30000 to 40000, more preferably 33000 to 38000. The material forming the skin layer may consist essentially of a thermoplastic copolyester elastomer, for example, the content of the thermoplastic copolyester elastomer in the material forming the skin layer may be 80 weight percent or more, preferably 85 weight percent or more, more preferably 90 weight percent or more. Conventional additives (including but not limited to colorants, antioxidants, etc.) in the art may also be included in the material forming the cover layer. It should be understood that the addition of additives is used to properly adjust the properties of the system, which generally should not be too high. In this application, the material forming the surface layer may not include a resin (for example, a compatible resin), which is beneficial to the overall recovery of the component. According to an exemplary embodiment as shown schematically in the FIGURES, the cover layer may be formed from a thermoplastic copolyester elastomer by calendering and/or casting processes.

To balance the requirements for mechanical properties, tactile sensation, etc. in different use in a vehicle interior, the thickness, hardness, and density of the surface layer may be selected/designed so that the surface layer may obtain better matching on the material and structure, so that better use performance may be obtained when the requirements of the vehicle are met. The thickness of the surface layer may be 0.1-1.5 mm, preferably 0.3-1 mm; more preferably 0.5-0.8 mm. The thickness of the surface layer is too large, which may lead to an excessively high hardness of the skin, and the overall softness of the component is reduced, which may affect the hand feeling and comfort of the component. In addition, the thickness of the skin is too large, and the amount of the material is increased, which may cause the component cost to rise; and the thickness of the surface layer is too small, which may cause the skin strength to be too low, and may be easily broken during use. The hardness of the surface layer of the present disclosure may be 20 D to 60 D The hardness of the surface layer may be too high, which may cause the skin softness to be reduced, and the hand feeling and comfort may be reduced. The hardness of the surface layer is too low, which may cause the component to be easy to form, and the component strength is low. The density of the surface layer may be 1000-1200 kg/m surface layer with too high density, which may lead to a large component weight, which is not conducive to light weight and low cost, and the density increase may cause the surface hardness to increase, which affects the hand feeling and comfort of the component; and the density of the surface layer is too low, which causes the skin to be not dense enough, and the tensile strength and elongation at break cannot meet the requirements.

The material comprising the thermoplastic polyester elastomer may be made into a composite structure with cover/skin layer using a suitable processing process. For overall recycling and performance optimization, a compatible resin may not be included in the material for preparing the surface layer. As indicated schematically, a suitable processing process to obtain the surface layer properties may be selected. The composite structure may comprise calendering or casting processes. During the calendering process, the shear force produced between the rollers causes the thermoplastic copolyester elastomer material to be subjected to extrusion and shearing a plurality of times, increasing plasticity, and extending to a surface layer having a target thickness, density and hardness on the basis of plasticizing. Compared with other processing technologies (such as injection molding), calendering is used to help accurately adjust the density and hardness of the surface layer, so as to obtain the target surface layer. In addition, on the premise of ensuring component quality, the injection molding process has a certain limitation on the thickness of the obtained skin, which is usually difficult to prepare a surface layer with a thickness of 0.8 mm or less. The present application uses a calendering or casting process to prepare a surface skin, so that a high-quality surface layer with a lower thickness may be obtained. For a surface layer with a thickness of 0.5 mm or less, it may also be prepared by a calendering or casting process. The hardness of the skin obtained by injection molding is usually high, and it is difficult to prepare a surface layer with a hardness below 50 D by means of an injection molding process. In the present application, a surface layer of a calendering or casting process may be used to achieve a hardness of 40 D or less. As indicated schematically, a calendering or casting process may be used to prepare the surface layer; the surface layer may have a thinner and softer effect, so that the final tactile sensation of the whole component may be more excellent and lighter weight (e.g. compared to injection molding). As indicated schematically, in the skin with light transmission requirements, components prepared by calendering or casting processes may provide enhanced performance and properties.

A cover/coating a suitable coating/cover on the surface of the surface layer may impart excellent scratch resistance, abrasion resistance, lighting resistance, yellowing resistance prolonging the service life of the component; a coating may be on one or both sides of the cover layer. For cost considerations, the coating may be provided only on one side surface of the surface layer, and in actual use, the coating is on the side of the surface layer close to the user, that is, the user may contact or see the surface layer of the coating, so as to reduce the influence of external factors (such as light, scratch, etc.) on the component. The cover/coating may be formed from an aqueous polyurethane system and/or an acrylic system. The aqueous polyurethane system useful in the present invention may comprise water, an aqueous polyurethane resin (e.g. comprise a matting resin and/or a bright light resin), a curing agent (e.g. comprise a polycarbodiimide curing agent and/or an isocyanate curing agent). Depending on the required state of the material a leveling agent, a defoaming agent, a thickener and the like may be added in an appropriate amount in the aqueous polyurethane system. The coating formed by the aqueous polyurethane system may have a good binding force with the surface layer. The acrylic system may comprise an acrylic surface treatment agent (e.g.: Basic Composition: Water, aqueous acrylic resin, curing agent, auxiliary formula: In order to increase the binding force between the coating and the surface layer, a curing crosslinking agent or a modified resin that may react with the surface active group may be added to the acrylic system (for example, The modified resin such as the isocyanate curing crosslinking agent, the modified aqueous polyurethane resin, the modified aqueous acrylate resin has good adhesion between the coating formed by these systems and the surface layer, and the coating will not readily separate (a property beneficial to prolong the use cycle and make the component more environmentally friendly). The weight of the coating may be between 0.05 percent and 0.2 percent of the total weight of the composite structure. The weight ratio of the coating is too high, and the coating may adversely affect the overall recyclability of the component; the weight proportion of the coating is too low, and the performance of the surface cannot be fully optimized. The thickness of a suitable coating may improve the performance of the component and do not disrupt the overall recyclability of the component. The coating thickness may be 2-50 m, preferably 10-30 m, more preferably 10-20 m. The color of the surface layer and the coating may be adjusted according to the application scenario to provide a suitable appearance/visual experience.

As indicated schematically in FIGS. 11 and 11A, composite structure CS may comprise a surface layer 2 and a coating 1 on a surface of one side of the surface layer 2, and the composite structure may be suitable for an automobile interior component such as an instrument panel, a door panel, and a center console. The composite structure may include a foam layer, which may be on one side of the cover layer. The foam layer may be formed from a material comprising a thermoplastic polyester elastomer by a foaming process. In order to reduce the solvent residue that may be caused by chemical foaming, physical foaming may be used. The thermoplastic polyester elastomer foam formed from a material comprising a thermoplastic polyester elastomer is formed by a foaming process, has good resilience and support properties, and is suitable as a foam layer. The thermoplastic polyester elastomer of the foam layer comprises a hard segment and a soft segment. The hard segment of the thermoplastic polyester elastomer forming the foam layer may comprise poly (butylene terephthalate), poly (ethylene terephthalate), poly (trimethylene terephthalate), poly (trimethylene terephthalate)/poly (butylene terephthalate), poly (2,6-naphthalate), poly (trimethylene terephthalate), poly (ethylene terephthalate)/polybutylene terephthalate copolymers, poly (dimethyl terephthalate/m-xylylene)/1,4-butanediol copolymers, poly (2,5-furan dicarboxylate), poly (2,5-furandicarboxylic acid) propylene glycol ester, poly (2,5-furandicarboxylate), poly (2,5-furan dicarboxylate) and/or a combination; Preferably, the poly (butylene terephthalate), the poly (2,5-furandicarboxylate) and/or a combination may be included. The soft segment of the thermoplastic polyester elastomer forming the foam layer may comprise polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, and polyglycolide; preferably, may include polyethylene glycol, polycaprolactone, and polytetramethylene ether. In the thermoplastic copolyester elastomer forming the foam layer, the ratio of soft segments and hard segments may be in a suitable range to impart good performance to the foam layer. In the thermoplastic copolyester elastomer, the molar ratio of the hard segment to the entire copolyester elastomer may range from 30 percent to 60 percent, and the molar ratio of the soft section to the entire copolyester elastomer may range from 40 percent to 70 percent. The thermoplastic copolyester elastomer may have a molecular weight of 30,000 to 45,000.

According to the requirements of a vehicle interior, according to the material of the foam layer, the foam layer is reasonably designed according to the present disclosure, so that the thickness, the density, and the material are better matched, so that better use performance may be obtained when the requirements of the vehicle are met. The composite structure may comprise a first foam layer. The thickness and density of the first foam layer may adjust the user's sense of use. The thickness of the first foam layer may be 0.1-1 mm, preferably 0.3-0.8 mm, more preferably 0.3-0.5 mm. The thickness of the first foam layer is too high, which may cause the overall thickness of the skin to be too high, the coating property of the edge is affected, wrinkles are prone to appearance problems, etc. At the same time, the thickness of the foam layer is too high, which will increase the material usage of the foaming layer, so that the overall weight of the surface layer is increased, and the light weight requirement is not met; the thickness of the first foam layer is too low, which will cause insufficient soft touch of the surface layer, and the user's feeling of comfort and softness is reduced. The density of the first foam layer may be 100-300 kg/m, and preferably 150-200 kg/m of the first foam layer has an excessively high density, which may cause the hardness of the foam layer to become hard, the soft touch is not obvious, the weight of the foam layer is too high, and the weight of the foam layer is not satisfied; and the density of the first foam layer is too low, which will cause insufficient support force and easy collapse of the foam layer in a long-term use process. The first foam layer may increase the soft touch when the user just contacts the multi-layer material, improve the perceived softness of the user during stroking, impart a good user experience to the user, and enrich the component for a vehicle interior.

As indicated schematically in FIGS. 12 and 12A, composite structure CS comprises a coating 1, a surface layer 2 and a first foam layer 3, the first foam layer 3 and the coating 1 are respectively on two sides of the surface layer 2. The first foam layer 3 present in the composite structure may bring a better surface tactile feel to the user, and a softer and more comfortable user experience. An automotive interior component, such as a door panel, an instrument panel, a center console, etc. may be applied. The composite structure may comprise a second foam layer. The second foam layer is introduced into the composite structure, and the soft touch sensed by the user may be taken. The composite structure including the second foam layer is particularly suitable for a scenario in which there is a certain requirement for softness in the vehicle, for example, areas such as a seat cushion and a backrest of the seat, which may increase the softness of the seat cushion and the backrest, and improve the comfort of the vehicle occupant. The second foam layer may be a thermoplastic polyester elastomer foam of the sheet structure, so that compared with the first foam layer, the cell structure of the second foam layer may be looser, imparting a softer feel to the component. In order to increase the softness of the component, the second foam layer may have a relatively higher thickness and a lower density than the first foam layer. The thickness of the second foam layer may be 1-10 mm, preferably 3-6 mm. The density of the second foam layer may be 50-150 kg/m, preferably 70-100 kg/m.

As indicated schematically in FIGS. 15 and 15A, composite structure CS comprises a coating 1, a surface layer 2 and a second foam layer 5, the first foam layer 5 and the coating 1 are respectively on two sides of the surface layer 2. The second foam layer 3 present in the composite structure may make the soft touch of the component more obvious. It is particularly suitable for coating an automobile interior component, such as a seat, an armrest and the like.

The composite structure may also comprise a fabric layer. A function of setting the fabric layer is to increase the overall strength of the composite structure and reduce its ductility.

The material of the fabric layer may be made of a fiber formed by a polymer material (i.e. a polyester material) of the same type as the surface layer and the foam layer, facilitating the recycling of the composite structure after the service life of the composite structure is expired. The fibers formed from the thermoplastic polyester material may be thermoplastic polyester fibers, thermoplastic polyester elastomer fibers and/or a combination. Useful thermoplastic polyester fibers include polybutylene terephthalate fibers, polyethylene terephthalate fibers, polytrimethylene terephthalate fibers, or combinations thereof. The fabric layer formed by polybutylene terephthalate fibers has better performance (e.g. abrasion resistance, strength, tensile properties). A fabric layer may also be made by thermoplastic polyester elastomer fibers, the thermoplastic polyester elastomer comprises a hard segment and a soft segment. The hard segment may comprise poly (butylene terephthalate), polyethylene terephthalate, poly (trimethylene terephthalate), poly (trimethylene terephthalate)/poly (butylene terephthalate), poly (2,6-naphthalate), poly (trimethylene terephthalate), poly (ethylene terephthalate/poly (butylene terephthalate) copolymers, poly (dimethyl terephthalate)/(1,4-butanediol) copolymers, poly (2,5-furan dicarboxylate), poly (2,5-furan dicarboxylate), poly (2,5-furandicarboxylate), poly (2,5-furan dicarboxylate) and/or a combination, preferably comprising: Polybutylene terephthalate, poly2,5-furandicarboxylic acid butylene glycol ester and/or a combination. The soft segment may comprise polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, and polyglycolide, preferably including polyethylene glycol, polycaprolactone, and polytetramethylene ether. The fabric layer may be in the form of a woven or non-woven fabric. The fabric layer may be a polyester fiber cloth, preferably comprising a thermoplastic polyester elastomer fiber cloth and/or a polybutylene terephthalate fiber cloth. The fabric layer may impart good performance to the composite structure. The fabric layer has a suitable thickness, fabric density and tensile strength, so that the tensile properties and strength of the composite structure may be improved on the premise of meeting the requirements of the vehicle. The thickness of the fabric layer may be 0.1-1 mm, preferably 0.3-0.8 mm, more preferably 0.3-0.5 mm. The thickness of the fabric layer is too high, which may cause the hardness of the component to be hard, affect the softness and feel of the skin component, and when the skin has a light-transmitting functional requirement, the thickness of the fabric layer is too high to affect the light-transmitting function of the skin; the thickness of the fabric layer is too low, which will cause insufficient material strength, and when being stretched, the cover material is easy to crack, and during sewing, the cover material is prone to explosion or broken. The fabric surface density of the fabric layer may be too high for the fabric surface density of the fabric layer of 15-150 g/m, which may cause the fabric layer to be too dense, the hardness is increased, the hand feeling is affected, the weight is increased, the requirement of light weight is not met, and if the fabric layer is too dense, the light transmission requirement cannot be met; the fabric surface density is too low, which will cause insufficient strength of the fabric layer, is easy to be stretched, and the orientation is not easy to control. The fabric layer has a suitable material, thickness and areal density, so that the fabric layer has high tensile strength, improving component performance. The tensile strength of the fabric layer may be 100 N or more.

As indicated schematically, the composite structure comprising the skin may comprise one or more layers of fabric layers, and better component performance is obtained by matching with other layers. As indicated schematically in FIGS. 13 and 13A, composite structure CS comprises a coating 1, a surface layer 2 and a fabric layer 4, the fabric layer 4 and the coating 1 are respectively on two sides of the surface layer 2. The fabric layer 4 present in the composite structure may make the tensile properties and strength of the component more excellent. An automotive interior component, such as a door panel, an instrument panel, a center console, etc. may be applied. As indicated schematically, in the composite structure the fabric layer and the foam layer may be used in combination, so that the component may increase the tensile properties and strength of the component while maintaining the soft touch on the surface. The composite structure may comprise a surface layer, a coating, a foam layer, and a fabric layer, both the foam layer and the fabric layer being on a side of the surface layer facing away from the coating. The foam layer may be between the skin layer and the fabric layer. Such composite structures are particularly suitable for use in automotive seats, such as backrest, seat cushions.

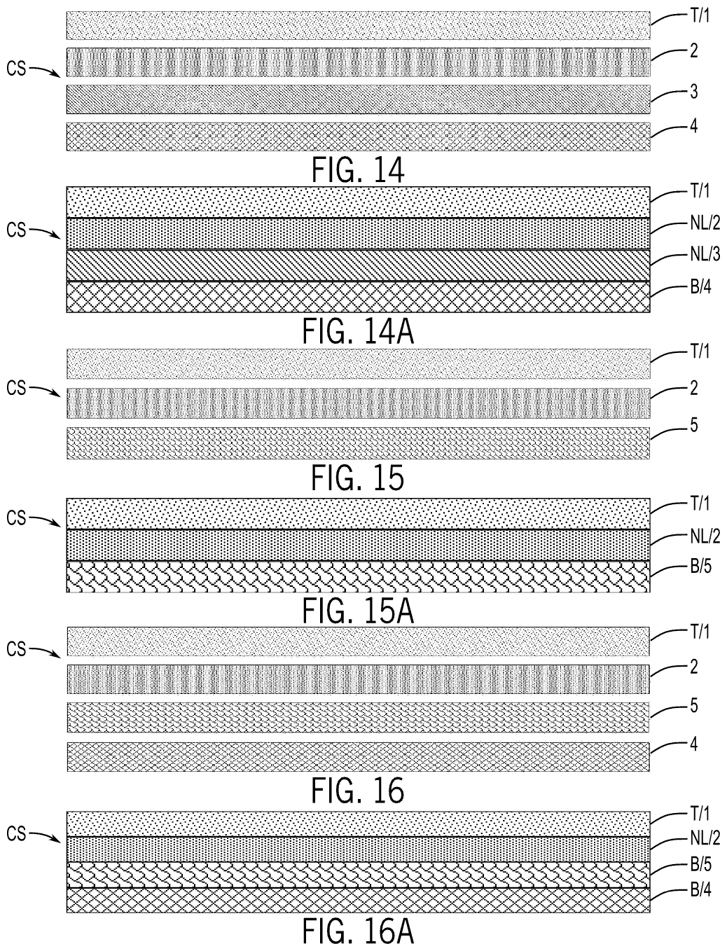

As indicated schematically in FIGS. 14 and 14A, composite structure CS may comprise a coating 1, a surface layer 2, a first foam layer 3, and a fabric layer 4, the first foam layer 3 and the fabric layer 4 are both on a side of the surface layer facing away from the coating layer, and the first foam layer 3 is between the surface layer 2 and the fabric layer 4. As indicated schematically, the composite structure may be suitable for coating internal components of an automobile, such as a door panel, an instrument panel, a center console, etc.

As indicated schematically in FIGS. 16 and 16A, composite structure CS may comprise a coating 1, a surface layer 2, a second foam layer 5, and a fabric layer 4, the second foam layer 5 and the fabric layer 4 are both on a side of the surface layer facing away from the coating. The second foam layer 5 is between the skin layer 2 and the fabric layer 4. As indicated schematically, the composite structure may be suitable for coating automotive interior components, such as armrests, seats, etc.

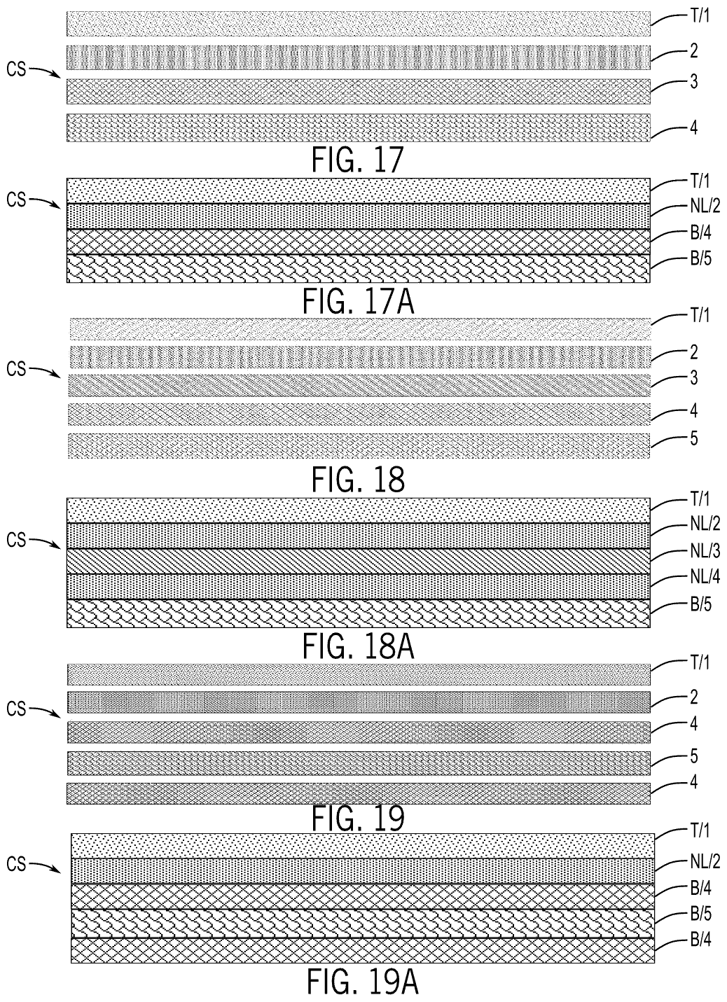

As indicated schematically in FIGS. 17 and 17A, composite structure CS may comprise a coating 1, a surface layer 2, a second foam layer 5, and a fabric layer 4, the second foam layer 5 and the fabric layer 4 are both on a side of the surface layer facing away from the coating, and the fabric layer 4 is between the surface layer 2 and the second foam layer 5. In the use scenario of the composite structure, in general, the area in contact or observed by the user is a surface layer coated with a coating. Since the fabric layer 4 is adjacent to the surface layer 2, the user contact area may be made more rigid and flat, and the fabric layer 4 has a better visual effect. As indicated schematically, the composite structure may be suitable for coating automotive interior components, such as armrests, seats, etc. The composite structure may comprise a surface layer, a coating layer, a first foam layer, a second foam layer, and a fabric layer, the first foam layer, the second foam layer, and the fabric layer are both on a side of the surface layer facing away from the coating layer. The first foam layer may be between the skin layer and the fabric layer. The fabric layer may be between the skin layer and the second foam layer.

As indicated schematically in FIGS. 18 and 18A, composite structure CS may comprise the coating 1, the surface layer 2, the first foam layer 3, the fabric layer 4, and the second foam layer 5, so that the tactile sensation of the composite structure is softer and the comfort level is increased. As indicated schematically, the composite structure may be suitable for coating automotive interior components, such as armrests, seats, etc.

As indicated schematically in FIGS. 19 and 19A, composite structure CS may comprise a coating 1, a surface layer 2, a fabric layer 4, a second foam layer 5, and a fabric layer 4, which are respectively at positions adjacent to the surface layer 2 and the second foam layer. In this way, the contact area of the user may be stiffer and flat, and the overall tensile strength and wear resistance of the component may be increased. As indicated schematically, the composite structure may be suitable for coating automotive interior components, such as armrests, seats, etc.

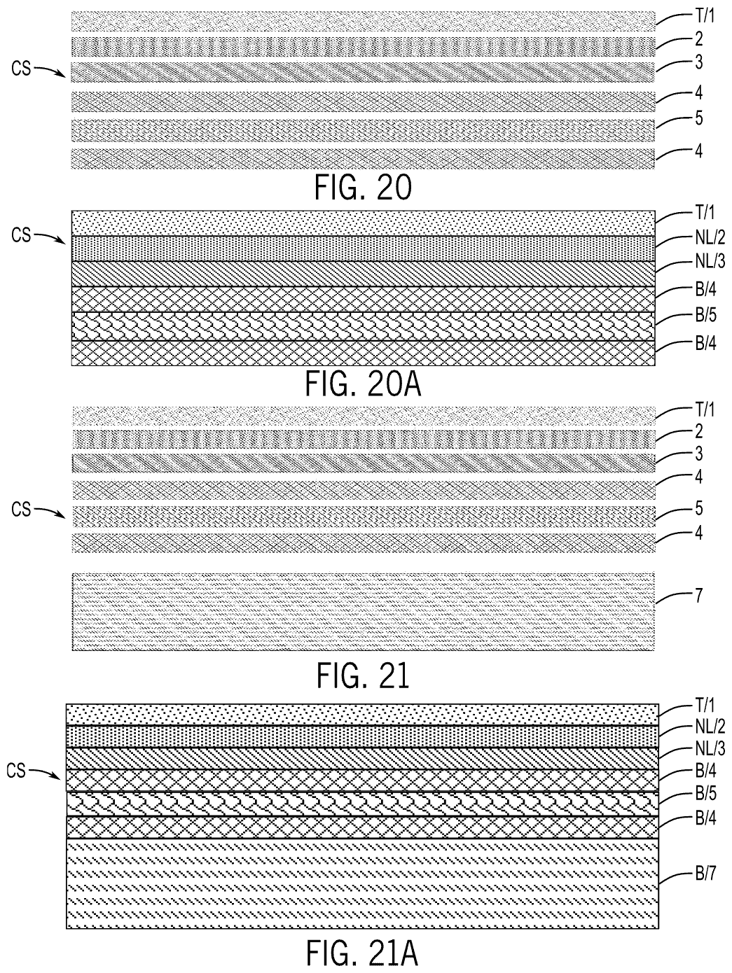

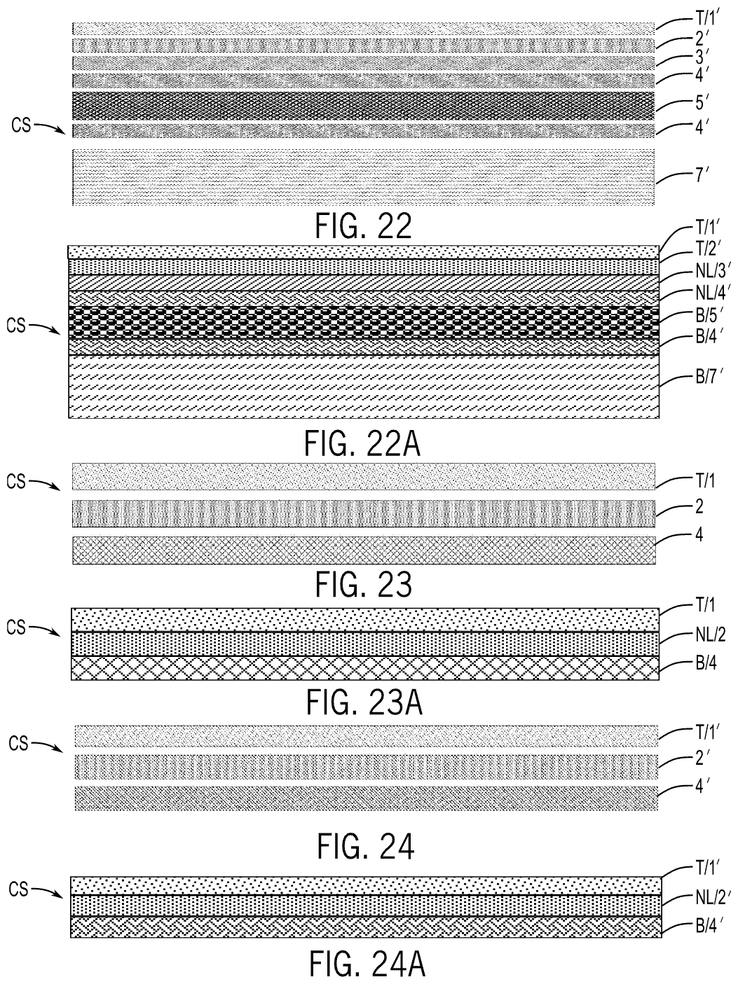

As indicated schematically in FIGS. 20 and 20A, the composite structure may comprise a coating 1, a surface layer 2, a first foam layer 3, a fabric layer 4, a second foam layer 5, and a fabric layer 4. As indicated schematically, the composite structure may be soft and comfortable on the whole touch, and the overall tensile strength and wear resistance are good. As indicated schematically, the composite structure may be suitable for coating automotive interior components, such as armrests, seats, etc.

Based on the consideration of overall recycling, the materials of each layer in the composite structure are made of polyester materials, so as to facilitate overall recovery. According to an exemplary embodiment as shown schematically in the FIGURES, based on the total weight of the composite structure, the content of the thermoplastic polyester material in the composite structure is above 70 percent, preferably over 85 percent, more preferably over 90 percent. In another embodiment, based on the total weight of the composite structure, the content of the thermoplastic polyester elastomer in the composite structure is above 60 percent, preferably over 85 percent, more preferably over 90 percent. The thermoplastic polyester or thermoplastic polyester elastomer in the epidermis has an excessively low content and cannot achieve the purpose of overall recycling. The material of each layer may be the same or different specific polyester types. In order to improve the reuse efficiency of the composite structure, the material of each layer in the composite structure may be made to have the same or similar polyester types as much as possible. After the service life of the component expires, the whole composite structure may be recovered without splitting directly, and the recycled material obtained after the recovery is relatively single.

According to an exemplary embodiment as shown schematically in the FIGURES, the hard segments in the thermoplastic polyester elastomer foam body constituting the foam layer (first and/or second foam layer) are the same as the hard segments of the thermoplastic copolyester elastomer constituting the skin layer. That is, the thermoplastic polyester elastomer forming the foam layer by foaming has the same repeating unit structure as the hard segment of the thermoplastic copolyester elastomer forming the skin layer.

According to an exemplary embodiment as shown schematically in the FIGURES, the soft segment of the thermoplastic polyester elastomer foam forming the foam layer (first and/or second foam layer) is the same as the type of soft segment of the thermoplastic copolyester elastomer constituting the skin layer. That is, the thermoplastic copolyester elastomer forming the foam layer by foaming has the same repeating unit structure as the soft segment of the thermoplastic polyester elastomer forming the skin layer.

According to an exemplary embodiment as shown schematically in the FIGURES, the hard segment of the thermoplastic copolyester elastomer constituting the skin layer is polybutylene terephthalate or poly 2,5-furandicarboxylic acid butylene glycol ester. The soft segment of the thermoplastic polyester elastomer constituting the skin layer is polytetramethylene or polycaprolactone. The hard segment of the thermoplastic polyester elastomer foam (the material of the first foam layer and/or the second foam layer) is polybutylene terephthalate or polyethylene terephthalate, preferably polybutylene terephthalate. The soft segment of the thermoplastic polyester elastomer foam is a polyester segment or a polyether segment. The fabric layer is polybutylene terephthalate fiber cloth.

A rich material form of the polybutylene terephthalate material may be used as the material of each layer in the composite structure. Specifically, the hard segment is a thermoplastic polyester elastomer having polybutylene terephthalate with good mechanical strength, elasticity and corrosion resistance. By calendering or casting, the thermoplastic polyester elastomer may be made into a surface layer that meets the requirements and has good performance. Thermoplastic polyester elastomers containing polybutylene terephthalate hard segments have good resiliency and suitable hardness by foaming. The abrasion resistance, strength and tensile properties of the fiber cloth formed from polybutylene terephthalate fibers are excellent. As indicated schematically, selecting polybutylene terephthalate as the constituent materials of each layer may reduce the number of polyester types introduced in the composite structure, which is beneficial to improving the reuse efficiency and reducing the operation difficulty of recycling (such as a physical recycling manner and a chemical recycling manner) may be provided; enhanced use performance, such as excellent strength, tensile properties, elasticity, etc. and may satisfy use requirements in the components of the vehicle.

As indicated schematically, enhanced environmental/recycling performance may be possible with the mono-material composite structure as a whole/unit indicated schematically in FIG. 25; for the polyolefin material, the hardness of the polyolefin material is difficult to reach below 75 A in the case that the compliance requirement is met. A component requirement that requires soft skin cannot be met. In addition, the inventors found that the foam layer made of the polyolefin material cannot reach the resilience of the foam layer; the polyolefin material is used as a fabric layer, and the tensile strength of the fabric layer is also lower than that of the fabric layer, so that the requirements of high-end vehicle requirements cannot be met; for a thermoplastic polyurethane elastomer material, a conventional aromatic polyurethane elastomer easily causes yellowing according to light conditions, and if light is light-colored, it cannot meet the requirements of the compliance level; while the aliphatic polyurethane elastomer tends to be relatively high in price, does not meet the low-cost requirement, and the aliphatic polyurethane elastomer is difficult to achieve low hardness and cannot meet the requirements of soft skin; for thermoplastic polystyrene elastomers (SBS elastomers), there is a double-end bond in the structure, which is easy to age and has poor heat resistance, and it is difficult to meet the requirements of the compliance level. However, the hard segment of the thermoplastic polyester elastomer used in the present application has high melting point and polarity, so the heat resistance and oil resistance are better than that of the SBS elastomer; for thermoplastic vulcanizate elastomers, sulfur bonds are provided in the thermoplastic vulcanizate elastomer, and the odor cannot meet the requirements of the compliance level at high temperatures, and therefore, the thermoplastic vulcanizate elastomer is not advantageous; for the thermoplastic polyamide elastomer, the performance is similar to that of the thermoplastic polyester elastomer, but the price is relatively high, which is not conducive to the market application.

The use of the component comprising the composite structure may provide enhanced properties in the vehicle interior; a cover/coating material of an in-vehicle internal component, for example, it may be used in the fields of instrument panels, door panels, center consoles, armrests, seats, etc. of a vehicle. The coating of the composite structure is on the side of the surface layer close to the user. That is, the user may contact or see the coated surface layer.

According to an exemplary embodiment as shown schematically in the FIGURES, the seat assembly comprises the composite structure. FIGS. 11 and 11A illustrates one embodiment of a seat assembly soft trim layer. The composite structure including the coating 1, the surface layer 2, the first foam layer 3, the fabric layer 4 and the second foam layer 5 is covered with the seat cushion (or backrest) 7 to form the automobile seat soft decoration layer. The covering of the composite structure with the seat cushion or backrest 7 may be carried out in a sewing manner. The suture may be a polyester fiber suture, such as a polybutylene terephthalate fiber suture. After the cover layer and the seat cushion (or the backrest) are bonded together, the surface layer and the seat cushion (or the backrest) may be engaged and bonded with the skeleton through the strip-shaped strip, and the strip used for clamping may be an injection molded or extruded thermoplastic polyester elastomer. After the service life of the component expires, the skeleton may be detached from the soft decorative layer, and the soft decorative layer (which may comprise the composite structure and the seat cushion (or backrest)) may be recycled as a whole.

According to an exemplary embodiment as shown schematically in the FIGURES, the automotive interior trim comprises the composite structure. FIGS. 13 and 13A illustrates one embodiment of an automotive interior trim layer. The inner trim layer is a composite structure including a coating 1, a skin layer 2, and a fabric layer 4. The soft decorative layer may be attached to the skeleton by a thermoplastic polyester glue. After the service life of the component expires, the skeleton and the soft decoration layer are separated, and the inner decoration layer (i.e. the composite structure) may be recycled as a whole/unit. The recovery of the soft layer may be carried out by physical recovery or chemical recovery. A feasible route for physical recovery is as follows: after the soft decorative layer containing the composite structure may be disassembled from the internal components of the vehicle, it is not necessary to split the soft decorative layer containing the composite structure, and the whole is directly crushed and recycled, and then the powder may be extruded through a twin-screw extruder, granulated to obtain recycled thermoplastic polyester particles, and the recycled particles may be used for repreparing the composite structure, or applied to other fields related to the polyester. One feasible route for chemical recovery is as follows: after the soft decorative layer containing the composite structure may be disassembled, the corresponding monomers and monomers may be obtained through alkali dissolution and fractionation to obtain the corresponding polymer material.

### Exemplary Embodiments—C

According to an exemplary embodiment as shown schematically in the FIGURES, a composite structure for an interior of a vehicle and a vehicle interior component may comprise material of construction configured to promote environmental protection and sustainable development; with the increasing demand for carbon emission, recyclable materials are used and recovered after the component end of life in an attempt to reduce net carbon emissions. A composite structure comprising a skin layer, cover, base, etc. for a component may comprise mixed materials such as different polymer materials, for example, polyvinyl chloride (PVC), polyurethane (PU), polyethylene terephthalate (PET); a foam material may comprise a polyurethane (PU) foam material generally considered to be a non-recyclable thermosetting material; if the component comprises mixed materials, at end of life to recover materials from the component for recycling/reuse each layer of material needs to be split and separated; the split/separate materials is generally an inefficient process that may cause recycling to be prohibitively difficult or costly/inefficient. It is known to provide an automobile seat cloth of materials that have suitable performance in use but that are not of a construction to facilitate efficient recycling at end of life (due to use of multiple mixed materials). An improved component with an improved composite structure comprising materials of a common polymer family may provide advantages of enhanced environmental protection and performance.

An improved composite structure for an interior of a vehicle may comprise a composite structure such as a cover/skin layer providing a surface layer formed by a calendering and/or casting process from a material comprising a thermoplastic copolyester elastomer; the thermoplastic copolyester elastomer forming the skin layer comprises a hard segment and a soft segment, the hard segment of the thermoplastic copolyester elastomer forming the skin layer comprising: poly (butylene terephthalate), poly (ethylene terephthalate), poly (trimethylene terephthalate), poly (trimethylene terephthalate)/poly (butylene terephthalate), poly (2,6-naphthalate), poly (trimethylene terephthalate), poly (ethylene terephthalate)/polybutylene terephthalate copolymers, poly (dimethyl terephthalate/m-xylylene)/1,4-butanediol copolymers, poly (2,5-furan dicarboxylate), poly (2,5-furandicarboxylic acid) propylene glycol ester, poly (2,5-furandicarboxylate), poly (2,5-furan dicarboxylate) and/or a combination; the method of forming may preferably comprise use of polybutylene terephthalate, poly (2,5-furandicarboxylate) and/or a combination; The soft segment of the thermoplastic copolyester elastomer forming the surface layer may comprise: polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide and/or a combination; the method of forming may preferably comprise use of polyethylene glycol, polycaprolactone, polytetramethylene ether and/or a combination.

According to an exemplary embodiment as shown schematically in the FIGURES, the composite structure may comprise a foam layer formed from a material comprising a thermoplastic copolyester elastomer by a foaming process.

According to an exemplary embodiment as shown schematically in the FIGURES, the composite structure comprises a fabric layer; the fabric layer is made of fibers formed from a thermoplastic polyester material, the fibers formed from the thermoplastic polyester material comprise thermoplastic polyester fibers, thermoplastic polyester elastomer fibers and/or a combination.

As indicated schematically in according to an exemplary embodiment in FIGS. 11 and 11A, a composite structure comprising a cover T and a base B may be provided for a component for a vehicle interior such as a seat assembly (e.g. to provide a seat soft trim layer).

As indicated schematically in according to an exemplary embodiment in FIGS. 12-12A. 13-13A, 14-14A, 15-15A, 16-16A, 17-17A, 18-18A, 19-19A, 20-20A, 21-21A, 22-22A, 23-23A and 24-24A, a composite structure comprising a cover T and an intermediate layer NL and a base B may be provided for a component for a vehicle interior such as a seat assembly, console, trim panel, etc.; the composite structure comprises a multilayer structure; each layer structure (such as the material, hardness, thickness, relative positional relationship, etc. of each layer) included in the layer structure is reasonably designed to impart properties to the composite structure so that the composite structure provided suitable characteristics of environmental protection as well as suitable performance in the vehicle interior. As indicated schematically in FIGS. 11-11A, 12-12A. 13-13A, 14-14A, 15-15A, 16-16A, 17-17A, 18-18A, 19-19A, 20-20A, 21-21A, 22-22A, 23-23A and 24-24A, a wide variety of materials of construction may be provided in a wide variety of configurations of the composite structure; selection of materials of construction may be based on performance in the vehicle interior during the life of the component and recovery by recycling of materials of the composite structure at end of life. See FIG. 25. As indicated schematically in FIG. 25, materials of each layer in the composite structure may comprise a same type of materials as will facilitate recovery of materials after the service life is expired.

The structure of the automobile seat soft decorative layer of Example 1 is shown in FIGS. 11 and 11A. The method sequentially may comprise a cover shown as coating 1 formed from an aqueous polyurethane coating system comprising water, an aqueous polyurethane matting resin, a carbodiimide curing agent, and a coating thickness of 20 m; a surface layer 2, which is a thermoplastic copolyester elastomer A, the hard segment is polybutylene terephthalate, the soft segment is polytetramethylene ether, the hard segment accounts for 30 percent of the thermoplastic copolyester elastomer A, the soft segment accounts for 70 percent of the thermoplastic copolyester elastomer A, the molecular weight range is 33000-35,000, the surface layer thickness is 0.3 mm, the hardness is 20 D, and the surface density is 1000 kg/m; a first foam layer 3, which is a thermoplastic polyester elastomer foam, the hard segment is polybutylene terephthalate, the soft segment is polyethylene glycol, the hard segment accounts for 35 percent of the thermoplastic copolyester elastomer, the soft segment accounts for 65 percent of the thermoplastic copolyester elastomer, the molecular weight range is 30000-45000, the foam layer has a thickness of 0.5 mm, and the foam layer density is 100 kg/m; a fabric layer 4, which is a polybutylene terephthalate fiber cloth with a thickness of 0.3 mm and a fabric surface density of 15 g/m; a second foam layer 5, which is a thermoplastic polyester elastomer foam, the hard segment is polyethylene terephthalate, the soft segment is polyethylene glycol, the hard segment accounts for 25 percent of the thermoplastic copolyester elastomer, the soft segment accounts for 75 percent of the thermoplastic copolyester elastomer, the molecular weight range is 30,000-40000, the foam layer has a thickness of 3 mm, and the foam layer density is 50 kg/m; a fabric layer 4, which is a polybutylene terephthalate fiber cloth with a thickness of 0.8 mm and a fabric surface density of 100 g/m; and a cushion 7 (or backrest 7), which is a thermoplastic polyester elastomer foam.

An exemplary embodiment of a component (Comparative Example 1) is shown schematically in FIGS. 12 and 12A; the composite structure may comprise a cover/coating 1′, PVC/PU surface layer 2′, a PU foam layer 3′, PET fabric layer 4′, PUR foam layer 5′, PET fabric layer 6′, and PUR foam cushion 7′ (or backrest 7′).

An exemplary embodiment of a component (Example 2) is shown in FIGS. 13 and 13A; a method of forming the composite structure may comprise coating 1, formed from an aqueous polyacrylic acid coating system (which comprises water, an aqueous acrylic resin, a modified curing agent, a leveling agent, etc.), with a coating thickness of 30 m; a surface layer 2, which is a thermoplastic copolyester elastomer B, the hard segment is poly (2,5-furandicarboxylic acid) butylene glycol ester, the soft segment is polycaprolactone, the molar ratio of the hard segment to the thermoplastic copolyester elastomer B is 40 percent, the molar ratio of the soft segment to the thermoplastic copolyester elastomer B is 60 percent, the molecular weight range is 25000-35,000, the surface layer thickness is 0.5 mm, the hardness is 40D, and the surface density is 1100 kg/m; and the fabric layer 4 is a polybutylene terephthalate fiber cloth with a thickness of 1 mm and a fabric surface density of 70 g/m.

An exemplary embodiment of a component (Comparative Example 2 is shown in FIGS. 14 and 14A, the composite structure may comprise cover/coating 1′, PVC/PU skin layer 2′, and PET fabric layer 4′.

As indicated in TABLE 1, comparative data for examples and comparative examples may be provided.

TABLE 1

| | | Does it | | |
|---|---|---|---|---|
| | | Contain Non- | | |
| | Product | Recyclable | Recycling | Recycling |
| | Type | Materials? | Methods | Efficiency |
| Example 1 | Vehicle | No | No need for | High |
| | Seats Soft | | layered | |
| | Trim Layer | | disassembly; | |
| | | | recycle as a | |
| | | | whole. | |
| Comparative | | Yes | After being | Lower |
| TABLE 1 | | | separated | |
| | | | into layers, | |
| | | | the recyclable | |
| | | | components | |
| | | | must then be | |
| | | | recycled. | |
| Example 2 | Vehicle | No | No need for | High |
| | Interior | | layered | |
| | Soft Trim | | disassembly; | |
| | Layer | | recycle as a | |
| | | | whole. | |
| Comparative | | Yes | After being | Lower |
| TABLE 2 | | | separated | |
| | | | into layers, | |
| | | | the recyclable | |
| | | | components | |
| | | | must then be | |
| | | | recycled. | |

As indicated in TABLE 1, use of the composite structure in the vehicle interior may be suitable for requirements of a vehicle interior.

The non-recyclable materials are not included in Examples 1 and 2, and the materials of each layer are uniform. After the service life is expired, it is not necessary to split the layers, the recycling may be carried out as a whole on the composite structure as a unit, the recycling operation is convenient, and the recycling efficiency is high. A composite structure of non-recyclable material is included in Comparative Examples 1 and 2; non-recyclable parts need to be separated by splitting; then the recyclable part is recovered. Since the operation is complicated in the splitting process, the recycling operation step is less efficient and more cost-prohibitive; recycling efficiency is low.

The composite structure of Examples 1 and 2 of the present application was tested according to the following method, and the results are shown in TABLE 2. Fracture strength: test standard and method reference ISO 13934. Tear strength: test standard and method reference ISO 13937. Thermal aging: test instrument: environmental box and test method: the component was stored in an environment of 120 deg C. for 168 hours and then observed and evaluated. Crack resistance: Test standards and methods refer to ISO 11640. Flame Retardant: Test standards and methods refer to GB 8410. As indicated in TABLE 2, the composite structure may provide enhanced performance and meet the requirements of vehicle interior. See also FIG. 25.

TABLE 2

| Test Ideas | Qualification Standard | Test Results |
|---|---|---|
| Fracture Strength | ≥200N | Pass |
| Tear Strength (N) | ≥20 | Pass |
| Thermal Aging | No cracks, no significant | Pass |
| | color change, no interlayer | |
| | separation. | |
| Friction Colorfastness | ≥level 4 | Pass |
| Flame Retardant | ≤100 mm/min. | Pass |

As indicated in TABLE 3, using a thermoplastic copolyester elastomer is indicated to provide better comprehensive performance for the composite structure (e.g. cover/skin layer, base layer, etc.).

TABLE 3

| | Thermo- | Thermo- | Thermo- | | Thermo- | | |
|---|---|---|---|---|---|---|---|
| | plastic | plastic | plastic | Thermo- | plastic | Thermo- | Thermo- |
| | Polyester | Polyurethane | Polyurethane | plastic | vulcanized | plastic | plastic |
| | Elastomer | Elastomer | Elastomer | polystyrene | rubber | polyamide | polyolefin |
| | (TPC) | (Aliphatic) | (Aromatic) | elastomer | elastomers | elastomer | elastomer |
| Odor | No | No | No | Moderate | Distinct | No | No |
| | unpleasant | unpleasant | unpleasant | unpleasant | unpleasant | unpleasant | unpleasant |
| | odor | odor | odor | odor | odor | odor | odor |
| Heat | Excellent | Excellent | Excellent | Poor | Medium | Excellent | Medium |
| Resistance | | | | | | | |
| Resistance to | Excellent | Poor | Excellent | Poor | Medium | Excellent | Medium |
| Yellowing and | | | | | | | |
| Aging | | | | | | | |
| Minimum | Lower | Lower | Medium | Relatively | Relatively | Lower | Relatively |
| Achievable | | | | High | High | | High |
| Hardness* | | | | | | | |
| Cost | Medium | Medium | Relatively | Lower | Medium | Relatively | Relatively |
| | | | High | | | High | High |
| Comprehensive | Excellent | Medium | Medium | Poor | Medium | Medium | Medium |
| Assessment | | | | | | | |

*Refers to the lowest hardness that may be achieved by the component while meeting automotive specifications.

The lowest hardness that may be achieved refers to the lowest hardness that may be obtained by the component on the premise that the component meets the requirements of the vehicle.

As indicated schematically in according to an exemplary embodiment in FIGS. 12-12A. 13-13A, 14-14A, 15-15A, 16-16A, 17-17A, 18-18A, 19-19A, 20-20A, 21-21A, 22-22A, 23-23A and 24-24A, a composite structure for an interior of a vehicle comprising a composite structure comprising a skin layer may be formed from a material comprising a thermoplastic copolyester elastomer by calendering and/or casting processes, the thermoplastic copolyester elastomer forming the skin layer comprises a hard segment and a soft segment; the hard segment of the thermoplastic copolyester elastomer forming the skin layer may comprise poly (butylene terephthalate), poly (ethylene terephthalate), poly (trimethylene terephthalate), poly (trimethylene terephthalate)/poly (butylene terephthalate), poly (2,6-naphthalate), poly (trimethylene terephthalate), poly (ethylene terephthalate)/polybutylene terephthalate copolymers, poly (dimethyl terephthalate/m-xylylene)/1,4-butanediol copolymers, poly (2,5-furan dicarboxylate), poly (2,5-furandicarboxylic acid) propylene glycol ester, poly (2,5-furandicarboxylate), poly (2,5-furan dicarboxylate) and/or a combination; Preferably, the method may comprise polybutylene terephthalate, poly (2,5-furandicarboxylate) and/or a combination; the soft segment of the thermoplastic copolyester elastomer forming the surface layer may comprise: polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide and/or a combination; preferably, polyethylene glycol, polycaprolactone, polytetramethylene ether and/or a combination.

According to an exemplary embodiment as shown schematically in the FIGURES, the surface layer has a thickness of 0.1-1.5 mm, preferably 0.3-1 mm; more preferably 0.5-0.8 mm; and/or the surface layer has a hardness of 20-60 D; and/or the surface layer has a density of 1000-1200 kg/m.

According to an exemplary embodiment as shown schematically in the FIGURES, in a thermoplastic copolyester elastomer forming the surface layer, a molar ratio of the hard segment to the thermoplastic copolyester elastomer is 25 percent −60 percent, preferably 30 percent −40 percent; and/or in the thermoplastic copolyester elastomer forming the surface layer, a molar ratio of the soft segment to the thermoplastic copolyester elastomer is 40 percent −75 percent, preferably 60 percent −70 percent.

According to an exemplary embodiment as shown schematically in the FIGURES, the surface of the skin layer is provided with a coating, and the coating is formed by an aqueous polyurethane system and/or an acrylic system, the weight of the coating is 0.05 percent −0.2 percent of the total weight of the composite structure; and/or the coating has a thickness of 2-50 m, preferably 10-30 m; more preferably 10-20 m.

According to an exemplary embodiment as shown schematically in the FIGURES, the composite structure comprises a foam layer; the foam layer is formed from a material comprising a thermoplastic polyester elastomer by a foaming process.

According to an exemplary embodiment as shown schematically in the FIGURES, the foam layer may comprise a first foam layer and/or a second foam layer; the thickness of the first foam layer is 0.1-1 mm, preferably 0.3-0.8 mm, more preferably 0.3-0.5 mm; and/or the first foam layer has a density of 100-300 kg/m, preferably 150-200 kg/m; and/or the second foam layer has a thickness of 1-10 mm, preferably 3-6 mm; and/or the density of the second foam layer is 50-150 kg/m, preferably 70-100 kg/m.

According to an exemplary embodiment as shown schematically in the FIGURES, the composite structure may comprise a fabric layer; the fabric layer is made of fibers formed from a thermoplastic polyester material, the fibers formed from the thermoplastic polyester material comprise thermoplastic polyester fibers, thermoplastic polyester elastomer fibers and/or a combination.

According to an exemplary embodiment as shown schematically in the FIGURES, the fabric layer may comprise polybutylene terephthalate fiber cloth, thermoplastic copolyester elastomer fiber cloth and/or a combination.

According to an exemplary embodiment as shown schematically in the FIGURES, the fabric layer has a thickness of 0.1-1 mm, preferably 0.3-0.8 mm, more preferably 0.3-0.5 mm; and/or a fabric surface density of the fabric layer is 15-150 g/m; and/or the tensile strength of the fabric layer is 100 N or more.

According to an exemplary embodiment as shown schematically in the FIGURES, the content of the thermoplastic polyester material in the composite structure is more than 70 percent, preferably 85 percent or more, based on the total weight of the composite structure; and/or based on the total weight of the composite structure, the content of the thermoplastic polyester elastomer in the composite structure is 60 percent or more, preferably 85 percent or more.

According to an exemplary embodiment as shown schematically in the FIGURES, the content of the thermoplastic polyester material in the composite structure is more than 70 percent, preferably 85 percent or more, based on the total weight of the composite structure; and/or based on the total weight of the composite structure, the content of the thermoplastic polyester elastomer in the composite structure is 60 percent or more, preferably 85 percent or more.

According to an exemplary embodiment as shown schematically in the FIGURES, the composite structure may comprise the surface layer, the fabric layer, and the first foam layer; the fabric layer and the first foam layer are on the same side of the surface layer; the first foam layer is between the surface layer and the fabric layer.

According to an exemplary embodiment as shown schematically in the FIGURES, the composite structure may comprises the surface layer, the fabric layer, and the second foam layer; the fabric layer and the second foam layer are on the same side of the surface layer; the second foam layer is between the surface layer and the fabric layer.

According to an exemplary embodiment as shown schematically in the FIGURES, the composite structure may comprise the surface layer, the fabric layer, and the second foam layer; the fabric layer and the second foam layer are on the same side of the surface layer the fabric layer is between the surface layer and the second foam layer.

According to an exemplary embodiment as shown schematically in the FIGURES, the composite structure may comprise the surface layer, the fabric layer, the first foam layer and the second foam layer; the fabric layer, the first foam layer and the second foam layer are on the same side of the surface layer; the first foam layer is between the skin layer and the fabric layer, and the fabric layer is between the skin layer and the second foam layer.

According to an exemplary embodiment as shown schematically in the FIGURES, the composite structure may comprise the fabric layer on a side of the second foam layer facing away from the cover layer.

According to an exemplary embodiment as shown schematically in the FIGURES, the composite structure may comprise a surface layer formed from a material comprising a thermoplastic copolyester elastomer by means of a calendering and/or tape casting process, the thermoplastic copolyester elastomer forming the surface layer comprises a hard segment and a soft segment. The composite structure for the interior of the vehicle may be integrally recycled without splitting, has the advantages of being green and environmentally friendly, and has good market application prospects.

According to an exemplary embodiment as shown schematically in the FIGURES, the vehicle interior component may comprise an instrument panel, a door panel, a center console, an armrest or a seat/seat assembly.

TABLE A
REFERENCE SYMBOL LIST

| REFERENCE | |
|---|---|
| SYMBOL | ELEMENT, PART OR COMPONENT |
| V | Vehicle |
| VI | Interior |
| C | Component |
| DP | Door Panel |
| FC | Console (Center/Floor Console) |
| IP | Instrument Panel |
| AR | Armrest (Section) |
| F | Frame |
| SF | Seat Frame |
| CS | Composite structure |
| T | Cover (surface layer, coating, cover layer etc.) |
| NL | Intermediate layer (fabric, foam, foam layer, etc.) |
| B | Base (base layer, core section, foam layer, foam material, |
| | fabric, etc.) |
| R | Recycle/reclaim/reuse polymer material (mono-material |
| | (e.g. polymer, plastic/resin, etc.) |
| 1 | Cover (coating layer, etc.) |
| 1′ | Coating/cover |
| 2 | Surface layer/cover |
| 2′ | PVC/PU Surface layer |
| 3 | Foam layer |
| 3′ | PU Foam layer |
| 4 | Fabric layer |
| 4′, 6′ | PET Fabric layer |
| 5 | Foam layer |
| 5′ | PUR Foam layer |
| 7 | Cushion/backrest |
| 7′ | PUR Foam cushion/backrest |

It is important to note that the present inventions (e.g. inventive concepts, etc.) have been described in the specification and/or illustrated in the FIGURES of the present patent document according to exemplary embodiments; the embodiments are presented by way of example only and are not intended as a limitation on the scopes. The construction and/or arrangement of the elements of the inventive concepts embodied in the present inventions as described in the specification and/or illustrated in the FIGURES is illustrative only. Although exemplary embodiments have been described in the present patent document, a person of ordinary skill in the art will readily appreciate that equivalents, modifications, variations, etc. of the subject matter of the exemplary embodiments and alternative embodiments are possible and contemplated as being within the scopes; all such subject matter (e.g. modifications, variations, embodiments, combinations, equivalents, etc.) is intended to be included within the scopes. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scopes; all such subject matter (e.g. modifications, variations, embodiments, combinations, equivalents, etc.) is intended to be included within the scopes. The scope is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matters (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scopes.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scopes of the present patent document.

The invention claimed is:

1. A component for a vehicle interior configured to facilitate recycling and reuse of material of construction at end of life comprising:
an assembly comprising a composite structure;
wherein the composite structure as a unit comprises a cover and a base;
wherein the composite structure as the unit comprises material of construction;
wherein material of construction for the composite structure as the unit comprise recyclable materials; and
wherein the assembly is configured to be disassembled to facilitate recycling and reuse of material of construction of the composite structure as the unit.

2. The component of claim 1 wherein the assembly comprises a frame; wherein the composite structure is formed on the frame; and wherein the frame comprises a metal material.

3. The component of claim 1 wherein the composite structure as the unit comprises an intermediate layer between the cover and the base.

4. The component of claim 1 wherein the assembly is configured to be disassembled to facilitate recovery of material of construction of the composite structure as the unit by separation of the composite structure as the unit from the frame and reducing of the composite structure as the unit by a mechanical process for reclaiming and recovery of material of construction.

5. The component for claim 4 wherein the mechanical process comprises shredding.

6. The component of claim 1 wherein the assembly comprises a seat assembly; wherein the seat assembly comprises a seat back and a seat cushion.

7. The component of claim 1 wherein the cover comprises a skin layer comprising a polymer material comprising a generally rigid segment formed to provide an exterior surface comprising a decorative effect for the composite structure.

8. The component for claim 1 wherein material of construction of the composite structure comprises a polymer material selected from a group of polymer materials comprising (a) a polyolefin group; (b) a thermoplastic elastomeric group; (c) an elastomeric group; (d) thermoplastic copolymer elastomer; (e) thermoplastic copolyester elastomer; (f) thermoplastic polymer; (g) polymer material; (h) resin material.

9. The component of claim 8 wherein the group of polymer materials of material of construction for the composite structure as a unit comprises a mono-material for recyclability; wherein the mono-material comprises a single material group.

10. The component of claim 1 wherein material of construction of the composite structure comprises a thermoplastic polyester material comprising more than 70 percent of total weight of the composite structure.

11. The component of claim 1 wherein the composite structure is configured to provide a surface effect at the cover; wherein the surface effect comprises at least one of (a) softness; (b) compressibility, (c) elastic deformability; (d) resilience; (e) decorative appearance; (f) visual effect; (g) durability.

12. The component of claim 1 wherein the base of the composite structure comprises a foam material.

13. The component of claim 1 wherein the base of the composite structure comprises a fabric layer.

14. The component of claim 8 wherein the composite structure comprises a generally rigid segment and a generally compressible segment.

15. The component of claim 8 wherein ratio of a generally rigid segment of the thermoplastic polymer of the composite structure comprises from between 25 to 60 percent of total thermoplastic polymer; wherein ratio of a generally compressible segment of the thermoplastic polymer of the composite structure comprises from between 40 to 75 percent of total thermoplastic polymer.

16. The component of claim 1 wherein the composite structure comprises (a) the cover comprising a surface layer and (b) an intermediate layer comprising a first foam layer and a fabric layer and (c) the base comprising a second foam layer.

17. The component of claim 3 wherein the intermediate layer comprises at least two layers of recyclable material comprising a fabric material and a foam material providing a generally compressible segment between the cover and the base.

18. The component of claim 1 wherein material of construction for the composite structure comprises additives; and wherein additives comprise a colorant and/or an antioxidant.

19. A method of recovering materials of construction of a composite structure of a component for a vehicle interior to facilitate recycling and reuse of materials of construction at end of life of the component comprising the steps of:
providing the component as an assembly comprising the composite structure and a frame; separating the composite structure as a unit from the frame by disassembly;
shredding the composite structure as the unit to reduce materials of construction of the composite structure substantially as a whole;
reclaiming materials of construction of the composite structure substantially as the whole for reuse;
wherein materials of construction for the composite structure consist essentially of recyclable materials selected from a family of polymer materials;
wherein the assembly is configured to be disassembled to facilitate recycling and reuse of materials of construction of the composite structure.

20. The method of claim 19 wherein the composite structure as a unit comprises a cover and an intermediate layer and a base; wherein the composite structure as a unit is configured to be disassembled from the frame to facilitate recovery of materials of construction of the composite structure as the unit by separation of the composite structure as the unit from the frame and reducing of the composite structure as the unit by a mechanical process for reclaiming and recovery of materials of construction.
